(19) United States
(12) Patent Application Publication
(10) Pub. No.: US 2022/0368958 A1
(43) Pub. Date: Nov. 17, 2022

(54) LIVE VIDEO DISTRIBUTION METHOD USING UNMANNED MOVING DEVICE, VIDEO DISTRIBUTION DEVICE USED IN LIVE VIDEO DISTRIBUTION METHOD, AND VIDEO ARCHIVE DEVICE FOR STORING VIDEO DATA FILE GENERATED BY VIDEO DISTRIBUTION DEVICE

(71) Applicant: DAP REALIZE INC., Tokyo (JP)

(72) Inventor: Masahiro IZUTSU, Tokyo (JP)

(21) Appl. No.: 17/772,046

(22) PCT Filed: Oct. 29, 2020
(86) PCT No.: PCT/JP2020/040720

§ 371 Date: Apr. 26, 2022

(30) Foreign Application Priority Data
Oct. 30, 2019 (JP) 2019-197655
Nov. 24, 2019 (JP) 2019-211894
May 26, 2020 (JP) 2020-090984
May 31, 2020 (JP) 2020-095150
Jun. 23, 2020 (JP) 2020-107590

(51) Int. Cl. H04N 21/218; H04N 5/232; H04N 5/77; H04N 21/239; H04N 21/414

(52) U.S. Cl. CPC H04N 21/21805; H04N 5/23238; H04N 5/77; H04N 21/2393; H04N 21/41407; G06Q 50/14

(57) ABSTRACT

A live video distribution method includes transmitting a live video signal of a shooting target simultaneously from a video distribution device to a user device used by each of a plurality of users, and displaying the video of the live video signal on a display in the user device. The live video signal is generated based on the result of shooting the shooting target by an image capturing device provided by an unmanned moving device that moves in the space near the shooting target. The unmanned moving device moves based on a movement control signal generated based on the result of an operator other than the plurality of users operating the operator device.

### TECHNICAL FIELD

The present invention relates to a live video distribution method, and in particular, a live video distribution method for simultaneously transmitting a live video signal generated based on the result of shooting a shooting target by the image capturing means provided by the unmanned moving device to a plurality of user devices. It also relates to a video distribution device used in the live video distribution method. Further, the present invention relates to a video archive device for storing a video data file generated by the video distribution device.

### BACKGROUND ART

Tourism industry currently accounts for about 10% of the world's GDP, and is predicted to become the “largest industry in the 21st century” in the future.

Under these trends, we are not satisfied with tourism in traditional tourist destinations, and there is an increasing need for tourism in unexplored regions, as well as in frontier spaces such as outer space and the deep sea.

However, when many tourists rush to the unexplored region, the problem of destroying the rare natural environment and precious ruins arises. In addition, tourism in frontier spaces such as outer space and the deep sea not only costs a lot of money to go to the site, but also puts an excessive load on the body due to the influence of the surrounding environment such as weightlessness and high pressure. Moreover, there is a risk that life may be endangered if the means of transportation to the site (such as a spacecraft or a deep-sea research vessel) is damaged.

In addition, it takes time and cost to go to sightseeing spots not only in unexplored areas and frontier spaces, but also in general sightseeing, and, in particular, there is a problem that it is difficult for a person with a physical handicap to go to a tourist spot.

As a method for solving the above problems, a live video distribution method has been proposed that allows users to experience simulated sightseeing without going to sightseeing spots flying an aerial shoot unmanned aerial vehicle over areas such as tourist spots and transmitting a live video signal, which is generated based on the result of shooting a shooting target in the area by the image capturing means provided by the aerial shoot unmanned aerial vehicle, to a user device used by a user located at a location remote from the tourist spot, the user can experience a simulated sightseeing without going to the tourist spot.

However, in the conventional live video distribution method, the user at a remote location is required to have a certain level of skill for remotely controlling an unmanned aerial vehicle, since it is configuration in which the user remotely controls an aerial shoot unmanned aerial vehicle by controlling a user device at hand, relying only on the video of the live video signal transmitted from the aerial shoot unmanned aerial vehicle, without directly seeing the aerial shoot unmanned aerial vehicle.

In addition, the conventional live video distribution method has a problem that the enjoyment of “sightseeing experience” is not sufficiently enhanced in the case that each user is located far away from each other, since they can simply enjoy the local video and audio alone but cannot receive explanations from guides who have a wealth of knowledge about tourism targets, nor share their thoughts with each other, as in group sightseeing trips.

In addition, in the conventional live video distribution method, there is a problem that the video shooted by the aerial shoot unmanned aerial vehicle is only live distributed once, and the video shooted by the aerial shoot cannot be enjoyed after the fact.

### CITATION LIST

### Patent Literature

Patent document 1: Japanese Patent No. 6089256

### SUMMARY OF INVENTION

### Technical Problem

The present invention has been made in view of such circumstances. It is an object of the present invention to provide a live video distribution method which makes it possible for even users, who do not have the skills or qualifications to operate unmanned moving devices such as unmanned aerial vehicles, to enjoy the video of live video signals transmitted from unmanned moving devices that move in the space near the shooting target.

It is an another object to of the present invention to provide a live video distribution method which makes it possible for a plurality of users, who are far from each other, to simultaneously observe objects existing in tourist spots in real time, receive explanations from guides, and have dialogues and conversations with the feeling of being together at a tourist spot.

It is an another object to of the present invention to provide a video distribution device and a video archive device which makes it possible for users, who could not receive the live stream, to enjoy the video taken by the image capturing means of the unmanned moving device after the fact.

### Solution to Problem

In order to achieve above objectives, according to a first aspect of the present invention related to a live video distribution method, there is provided a live video distribution method comprising: transmitting a live video signal of a shooting target is simultaneously from a video distribution device to a user device used by each of a plurality of user; displaying the video of the live video signal on a display means provided in the user device; wherein the live video signal is generated based on the result of shooting the shooting target by the image capturing means provided by the unmanned moving device that moves in the space near the shooting target; and wherein the unmanned moving device moves based on a movement control signal generated based on the result of an operator other than the plurality of users operating the operator device.

In the first aspect of the present invention, as the unmanned moving device, unmanned vehicles and walking robots that move on the ground near the shooting target, an unmanned aerial vehicle that flies over the vicinity of the shooting target, or the like can be used.

Further, as a display means provided in the user device, a flat display panel such as a liquid crystal display or an organic EL (ElectroLuminescence) display, or a head mounted display (hereinafter abbreviated as “HMD”) can be used.

Further, the live video signal generated and transmitted by the unmanned moving device can be a three-dimensional (hereafter abbreviated as “3D”) video signal by using compound eye camera with a plurality of imaging units, or the like as the image capturing means of the unmanned moving device. In that case, the stereoscopic HMD is used as the display means provided by the user device, and the user device is provided with a “sensor for detecting the movement of the user's head or eyeball” from the left and right projection units of the stereoscopic HMD. Thus, it can be configured to project “an image of a visual field range adapted to the movement of the user's head or eyeball”, and as a result, an immersive visual experience can be provided to the user. Hereinafter, unless otherwise specified, the term “HMD” means “stereoscopic HMD”, and when the display means of the user device is an HMD, it is assumed that a 3D video signal that transmits both the image projected from the left projection unit of the HMD and the image projected from the right projection unit is transmitted to the user device.

And in order to achieve above objectives, according to a second aspect of the present invention related to a live video distribution method, there is provided a live video distribution method according to the first aspect of the present invention, wherein all or part of the plurality of users are located remote from the unmanned moving device; and wherein the video distribution device receives a live video signal from the unmanned moving device, performs necessary processing on the live video signal and then transmits it to the user device used by the user located at the remote location via the public network.

In the first or second aspect of the present invention, the video distribution device may be configured to directly receive the live video signal from the unmanned moving device and to receive the live video signal via a relay device such as a Wi-Fi router and/or via a public network.

Further, in the second aspect of the present invention, the internet can be used as the public network. Then, when the live video signal is transmitted via the internet, a video distribution server of a general-purpose platform such as YouTube (registered trademark), Instagram (registered trademark), Vimeo (registered trademark), etc. can be used as (a part of) the video distribution device. In this case, the live video signal is transmitted from the unmanned moving device to the user device by any of the following routes (1) or (2).
(1) unmanned moving device→video distribution device 1 internet→video distribution device 2 (video distribution server for general-purpose platform)→the internet→user device
(2) unmanned moving device→the internet→video distribution device (general-purpose platform video distribution server)→the internet→user device

Communication between each device and between each device and the internet can be appropriately performed via a relay device such as a Wi-Fi router.

Further, in the second aspect of the present invention, the network of the mobile communication system can be used as a part of the public network. Then, in that case, the video distribution device and/or the user device performs wireless communication with the mobile communication base station. At that time, in particular, by using the network of the 5th generation mobile communication system (hereinafter abbreviated as “5G”), high-resolution live video signals can be simultaneously transmitted to a large number of user devices with low delay.

And in order to achieve above objectives, according to a third aspect of the present invention related to a live video distribution method, there is provided a live video distribution method according to the first or the second aspect of the present invention, wherein the operator operates the operator device while directly viewing the unmanned moving device.

And in order to achieve above objectives, according to a fourth aspect of the present invention related to a live video distribution method, there is provided a live video distribution method according to the first or the second aspect of the present invention, wherein the operator device receives a live video signal generated by and transmitted from the unmanned moving device directly or via the video distribution device and/or public network, and displays the video of the live video signal by the display means provided in the operator device; and wherein the operator steers the operator device while watching the video of the live video signal displayed on the display means included in the operator device.

In the fourth aspect of the present invention, a flat display panel or an HMD can be used as the display means provided in the operator device. In particular, when an HMD is used, it can be configured to include a sensor for detecting the movement of the user's head or eyeball and to project “an image in a visual field range adapted to the movement of the user's head or eyeball” from the left and right projection units of the HMD.

Further, in the fourth aspect of the present invention, when the operator device receives the live video signal via the public network, the network of the mobile communication system can be used as a part of the public network. Then, in that case, the operator device performs wireless communication with the mobile communication base station. At that time, in particular, by using a 5G network, a high-resolution live video signal can be transmitted to the operator device with low delay.

And in order to achieve above objectives, according to a fifth aspect of the present invention related to a live video distribution method, there is provided a live video distribution method according to any one of the first to fourth aspects of the present invention, wherein the operator is located in a remote location from the unmanned moving device; and wherein the video distribution device receives a movement control signal from the operator device, performs necessary processing on the movement control signal, and then transmits the movement control signal to the unmanned moving device via a public network.

In the fifth aspect of the present invention, the network of the mobile communication system can be used as a part of the public network. Then, in that case, the video distribution device and/or the operator device performs wireless communication with the mobile communication base station. At that time, in particular, by using a 5G network, the movement control signal can be transmitted to the video distribution device with low delay.

And in order to achieve above objectives, according to a sixth aspect of the present invention related to a live video distribution method, there is provided a live video distribution method according to any one of the first to fifth aspects of the present invention, wherein there are a plurality of unmanned moving devices; wherein the plurality of unmanned moving devices simultaneously shoot substantially the same shooting target from different vantage points depending on the shooting means provided for each; and wherein a plurality of live video signals with different display ranges generated based on the result are simultaneously transmitted from the video distribution device to the user device.

The meanings of “viewpoint”, “line of sight”, “imaging range”, and “viewpoint (center of imaging range)” of image capturing means in the present specification and the like are as shown in FIG. 30.

Further, in the sixth aspect of the present invention, each of the user devices can receive only one live video signal among the “plurality of live video signals having different display ranges” at the same time. be able to. Further, each of the user devices may be configured to simultaneously receive a plurality of live video signals among the “plurality of live video signals having different display ranges”. In the latter case, the display means of the user device may display the videos of the received live video signals in parallel, or one of the received live video signals. It is also possible to display only the video of the live video signal. Then, in the last case, the video of the live video signal to be displayed can be switched by the user operating the user device.

Further, in the sixth aspect of the present invention, one operator may operate one unmanned moving device, or one operator may operate a plurality of unmanned moving devices. In the latter case, the risk of collision or crash can be reduced by adding the function of autonomous movement to the unmanned moving device.

And in order to achieve above objectives, according to a seventh aspect of the present invention related to a live video distribution method, there is provided a live video distribution method according to the sixth aspect, wherein each of the plurality of users selects which live video signal is received by their own user device among live video signals generated based on the result of shooting by the image capturing means of said plurality of unmanned moving devices and the video of the selected live video signal is displayed on the display means provided in the user device.

In the sixth aspect of the present invention, the user may be configured to select in advance before receiving the live video signal. Further, it is possible to switch to receive a live video signal generated based on the result taken by the image capturing means of another unmanned moving device while receiving a live video signal generated based on the result taken by the image capturing means of one unmanned moving device.

And in order to achieve above objectives, according to a eighth aspect of the present invention related to a live video distribution method, there is provided a live video distribution method according to any one of the first to seventh aspects, wherein there are a plurality of unmanned moving devices; wherein the plurality of unmanned moving devices are deployed in a plurality of areas remote from each other; and wherein each of the plurality of users selects which live video signal is received by their own user device among live video signals generated based on the result of shooting by the image capturing means of unmanned moving devices deployed in said plurality of areas and the video of the selected live video signal is displayed on the display means provided in the user device.

And in order to achieve above objectives, according to a ninth aspect of the present invention related to a live video distribution method, there is provided a live video distribution method according to any one of the first to eighth aspects of the present invention, wherein the image capturing means provided by the unmanned moving device captures a wide-angle image including a panoramic image, an hemispherical image, and a spherical image; and wherein a display means of the user device cuts out and displays an image in a predetermined display range (hereinafter abbreviated as “predetermined display range image”) from the wide-angle video.

Here, the “panoramic image” is an “image that can be seen 360 degrees in the horizontal direction”, and the “hemispherical image” is also called a “omnidirectional image”, and is an “image with a viewing angle (solid angle) of 180 degrees that covers the upper half of the field of view with a dome screen like a planetarium.”, and “spherical image” is an “image with a viewing angle (solid angle) of 360 degrees that covers the entire field of view from the front, back, left, and right overhead to the feet”, and the “wide-angle video” is an “image that extends over a wider range than the normal field of view ” such as “panoramic image”, “hemispherical (omnidirectional) image”, and “spherical image”.

In the ninth aspect of the present invention, a flat display panel or an HMD can be used as the display means provided in the user device. Further, the cutting out of the predetermined display range image from the wide-angle video may be performed by either the video distribution device or the user device. In particular, when the HMD is used as the display means provided in the user device, the user device is equipped with a “sensor that detects the movement of the user's head and eyeballs” and the predetermined display range image can be cut out from the wide-angle video by any of the following methods (1) and (2).
(1) The user device transmits a “signal based on the result of the sensor detecting the movement of the user's head and eyeball” to the video distribution device, the video distribution device generates a video signal that transmits “a video with a visual field range adapted to the movement of the user's head and eyeball” from the wide-angle video signal and transmits the video signal to the use device, and the user device projects an image based on the received video signal from the left and right projection units of the HMD.
(2) The user device transmits a “signal based on the result of the sensor detecting the movement of the user's head and eyeball” to the video distribution device, the video distribution device generates a video signal for transmitting “a video in a visual field range adapted to the movement of the user's head or eyeball” from the wide-angle video signal, and transmits the video signal to the user device, and the user device projects an image based on the received video signal from the left and right projection units of the HMD.

And in order to achieve above objectives, according to a tenth aspect of the present invention related to a live video distribution method, there is provided a live video distribution method according to any one of the first to ninth aspects of the present invention, wherein an audio signal, which is a collection of sounds emitted by an operator using the operator device or a person in the vicinity of the operator, (hereinafter abbreviated as “live operator audio signal”) is simultaneously transmitted from the video distribution device to the plurality of user devices directly or via a public network and live audio is simultaneously emitted by the sound emitting means of the plurality of user devices.

In the tenth aspect of the present invention, the “sound collecting means for collecting the sound emitted by the operator using the operator device or a person in the vicinity of the operator” may be configured as any of “configuration in which sound collecting means is included in the operator device”, “configuration in which sound collecting means is included in the video distribution device” or “configuration in which sound collecting means is installed independently of those devices”. Further, as the sound collecting means, a microphone can be used. In particular, in the configuration in which the operator device includes the sound collecting means, when the operator includes a display means such as a flat display panel or an HMD, the microphone can be integrated with the display means.

Further, as the sound emitting means included in the user device, a micro speaker can be used, and in particular, the sound emitting means can be integrated with a display means such as a flat display panel or an HMD provided in the user device.

And in order to achieve above objectives, according to a eleventh aspect of the present invention related to a live video distribution method, there is provided a live video distribution method according to tenth aspect of the present invention, wherein all or part of the plurality of user devices has a sound collecting means for collecting the sound emitted by the user who uses the user device; wherein all or part of the live user audio signal based on the result of sound collection by the user device sound collecting means and the superimposed audio signal superimposed with the live operator audio signal are directly or via a public network from the video distribution device; and wherein a live sound is simultaneously emitted by the sound emitting means of the plurality of user devices.

In the eleventh aspect of the present invention, for example, when there are four users A to D who use the user device, the video distribution device generates the following four types of superimposed audio signals, and the user A , B, C, and D can be configured to transmit superimposed audio signals A, B, C, and D (In the following, “live audio signal based on the result of sound collection by the sound collecting means of the operator device” and “live audio signal based on the result of sound collection by the sound collecting means of the user device used by user A” are abbreviated as “operator audio signal”, “user A audio signal”, etc.).
Superimposed audio signal A: An audio signal superimposed with “operator audio signal+user B audio signal+user C audio signal+user D audio signal”
Superimposed audio signal B: An audio signal superimposed with “operator audio signal+user A audio signal+user C audio signal+user D audio signal”
Superimposed audio signal C: An audio signal superimposed with “operator audio signal+user A audio signal+user B audio signal+user D audio signal”
Superimposed audio signal D: An audio signal superimposed with “operator audio signal+user A audio signal+user B audio signal+user C audio signal”

With such a configuration, each of the users A to D can avoid the unpleasant sensation associated with “listening to the voice emitted by himself/herself as an external voice”.

And in order to achieve above objectives, according to a twelfth aspect of the present invention relating to a video distribution device used in the live video distribution method, there is provided a video distribution device, the video distribution device used in the live video distribution method according to any one of the first to the eleventh aspects of the present invention: wherein a live video signal is received from the unmanned moving device, necessary processing is performed on the live video signal, and then the live video signal is simultaneously transmitted to the plurality of user devices directly or via a public network.

And in order to achieve above objectives, according to a thirteenth aspect of the present invention relating to a video distribution device used in the live video distribution method, there is provided a live video distribution device according to the twelfth aspects of the present invention, wherein A movement control signal is received from the operator device, necessary processing is performed on the movement control signal, and then the movement control signal is transmitted to the unmanned moving device directly or via a public network.

And in order to achieve above objectives, according to a fourteenth aspect of the present invention relating to a video distribution device used in the live video distribution method, there is provided a live video distribution device according to the twelfth or the thirteenth aspects of the present invention, the video distribution device used in the live video distribution method according to any one of the fourth to the eleventh aspects of the present invention: wherein a movement control signal is received from the operator device, necessary processing is performed on the movement control signal, and then the movement control signal is transmitted to the unmanned moving device directly or via a public network.

And in order to achieve above objectives, according to a fifteenth aspect of the present invention relating to a video distribution device used in the live video distribution method, there is provided a live video distribution device according to the twelfth or the fourteenth aspects of the present invention, the video distribution device used in the live video distribution method according to any one of the fifth to the eleventh aspects of the present invention: wherein a movement control signal is received from the operator device, necessary processing is performed on the movement control signal, and then the movement control signal is transmitted to the unmanned moving device via a public network.

And in order to achieve above objectives, according to a sixteenth aspect of the present invention relating to a video distribution device used in the live video distribution method, there is provided a live video distribution device according to any one of the twelfth to fifteenth aspects of the present invention, the video distribution device used in the live video distribution method according to any one of the sixth to eleventh aspects of the present invention: wherein live video signals with different image capturing ranges are received from each of the plurality of unmanned moving devices, necessary processing is performed for each of the live video signals with different image capturing ranges, and then they are simultaneously transmitted to the plurality of user devices directly or via a public network.

And in order to achieve above objectives, according to a seventeenth aspect of the present invention relating to a video distribution device used in the live video distribution method, there is provided a live video distribution device according to any one of the twelfth to the sixteenth aspects of the present invention, the video distribution device used in the live video distribution method according to the seventh to the eleventh aspects of the present invention: wherein an unmanned moving device selection signal based on the selection result of the user who uses the user device is received from the user device; and wherein it is determined to which user device the live video signal received from a plurality of unmanned moving devices is transmitted based on the unmanned moving device selection signal.

And in order to achieve above objectives, according to a eighteenth aspect of the present invention relating to a video distribution device used in the live video distribution method, there is provided a live video distribution device according to any one of the twelfth to the seventeenth aspects of the present invention, the video distribution device used in the live video distribution method according to the eighth to eleventh aspects of the present invention: wherein a region selection signal based on the selection result of the user who uses the user device is received from the user device; and wherein it is determined to which user device the live video signal received from a plurality of unmanned moving devices is transmitted based on the region selection signal.

And in order to achieve above objectives, according to a nineteenth aspect of the present invention relating to a video distribution device used in the live video distribution method, there is provided a live video distribution device according to any one of the twelfth to the eighteenth aspects of the present invention, the video distribution device used in the live video distribution method according to the ninth to the eleventh aspects of the present invention: wherein a wide-angle video signal is received from the unmanned moving device, necessary processing is performed on the wide-angle video signal, and then the wide-angle video signal is simultaneously transmitted to the plurality of user devices directly or via a public network.

And in order to achieve above objectives, according to a twentieth aspect of the present invention relating to a video distribution device used in the live video distribution method, there is provided a live video distribution device according to the nineteenth aspects of the present invention, wherein a predicted display range video signal for transmitting the predicted display range video cut out from the wide-angle image is generated, and the predicted display range video signal is transmitted to the user device.

In the twentieth aspect of the present invention, the video signal in the predetermined display range of the user device can be transmitted from the video distribution device by any of the following methods (1), (2) and (3).
(1) The user device is equipped with a “sensor that detects the movement of the user's head and eyeball”, and then the user device transmits a “signal based on the result detected by the sensor” to the video distribution device. And based on the received signal, the video distribution device sets “a visual field range adapted to the movement of the user's head or eyeball”, generates a video signal in a display range corresponding to the visual field range, and transmits video signal to user device.
(2) The video distribution device determines the display range based on the display range setting signal generated based on the result of the user operating the user device, generates the video signal in the specified display range, and transmits the video signal to user device.
(3) The video distribution device determines the display range regardless of the movement of the head or eyeball of the user using the user device or the operation of the user, generates a video signal in the specified display range, and transmits the video signal in the specified display range to the user device.

In particular, when the HMD is used as the display means provided by the user device, it is preferable to take the method (1), in which case the video distribution device transmits a 3D video signal composed of video signals projected from each of the left and right projection units of the HMD.

And in order to achieve above objectives, according to a twenty-first aspect of the present invention relating to a video distribution device used in the live video distribution method, there is provided a live video distribution device according to any one of the twelfth to twentieth aspects of the present invention, the video distribution device used in the live video distribution method according to the tenth or eleventh aspect of the present invention: wherein the live operator audio signal is simultaneously transmitted to the plurality of user devices, either directly or via a public network.

And in order to achieve above objectives, according to a twenty-second aspect of the present invention relating to a video distribution device used in the live video distribution method, there is provided a live video distribution device according to the twenty-first aspects of the present invention, the video distribution device used in the live video distribution method according to the eleventh aspects of the present invention: wherein a live user audio signal is received from all or a part of the plurality of user devices, and a superimposed audio signal is generated by superimposing the live operator audio signal on all or a part of the live user audio signal; and wherein the superimposed audio signal is simultaneously transmitted to the plurality of user devices, either directly or via a public network.

And in order to achieve above objectives, according to a twenty-third aspect of the present invention relating to a video distribution device used in the live video distribution method, there is provided a live video distribution device according to any one of the twelfth to the twenty-second aspects of the present invention, wherein recording of the video data transmitted by the live video signal is started substantially at the same time as the transmission of the live video signal is started, and the video data is saved as a video data file substantially at the same time as the transmission of the live video signal is completed.

And in order to achieve above objectives, according to a twenty-fourth aspect of the present invention relating to the video archive device is, there is provided a live video archive device for storing a video data file generated by the video distribution device according to the twenty-third aspect of the present invention.

In the twenty-fourth aspect of the present invention, the video distribution device and the video archive device can be integrally configured.

### Advantageous Effects of Invention

According to the live video distribution method of the present invention and a video distribution device used in the live video distribution method of the present invention, the unmanned moving device is operated only by the operator using the operator device, and other users can enjoy the video of the live video signal based on the result of shooting the shooting target by the image capturing means of the unmanned moving device without operating the unmanned moving device. Therefore, even a user who does not have the skill or qualification to remotely control the unmanned moving device can enjoy the video of the live video signal transmitted from the unmanned moving device moving in the space near the shooting target.

Further, according to the live video distribution method of the present invention and a video distribution device used in the live video distribution method of the present invention, a plurality of users enjoy “a video of a live video signal based on the result of shooting the shooting target by the image capturing means of an unmanned moving device remotely controlled by one operator”. Therefore, it is economical because the number of unmanned moving devices required is smaller than that of the conventional live video distribution method in which each user remotely controls the unmanned moving device.

Further, in particular, according to the live video distribution method of the second aspect of the present invention and the video distribution device used in the live video distribution method of the aspect, the user can enjoy the video of the live video signal shooted by the unmanned moving device even if the wireless signal from the unmanned moving device does not reach directly. Therefore, for example, the user can enjoy the video of the live video signal of the autumn leaves of Kyoto Arashiyama or can enjoy the video of the live video signal of wild animals in Africa, while staying in Tokyo, since the live video signal is transmitted from the unmanned moving device to the user device via a public network such as the intemet.

Further, in particular, according to the live video distribution method of the third aspect of the present invention and the video distribution device used in the live video distribution method of the aspect, it is possible to minimize the risk that the unmanned moving device collides with the shooting target or another unmanned moving device, and the shooting target or another unmanned moving device is damaged, since the operator controls the operator device while directly viewing the unmanned moving device. Therefore, this method or device is suitable for distributing a live video signal of a valuable archaeological site or a live video signal of a valuable exhibit of a museum.

Further, in particular, according to the live video distribution method of the fourth aspect of the present invention and the video distribution device used in the live video distribution method of the aspect, the operator displays the video of the live video signal captured by the unmanned moving device on the display means provided in the operator device used by the operator, and operates the operator device while watching the video of the live video signal. Therefore, the unmanned moving device can be moved to a place that is not sufficiently visible to the naked eye.

Further, in particular, according to the live video distribution method of the fifth aspect of the present invention and the video distribution device used in the live video distribution method of the aspect, the operator can operate the unmanned moving device even from a remote location where the wireless signal cannot be transmitted directly to the unmanned moving device, since the movement control signal is transmitted from the operator device to the unmanned moving device via a public network such as the intemet. Therefore, for example, an operator can fly an unmanned aerial vehicle over Kyoto Arashiyama or Africa while in Tokyo, while users can enjoy live video signals of autumn leaves and wildlife while in New York.

Further, in particular, according to the live video distribution method of the sixth aspect of the present invention and the video distribution device used in the live video distribution method of the aspect, for example, t The user can enjoy the fireworks from “top view”, “bottom view”, “side view”, etc. at the same time or while switching, by simultaneously shooting a fireworks launched at a fixed time with image capturing means provided by a plurality of unmanned moving devices at different positions.

Further, in particular, according to the live video distribution method of the seventh aspect of the present invention and the video distribution device used in the live video distribution method of the aspect, the user can select an unmanned moving device suitable for himself/herself and enjoy the video of the live video signal captured by the selected unmanned moving device based on, for example, the profile (gender, age, career, etc.) of each operator who controls each of the a plurality of unmanned moving devices, and the movement plan (movement route and moving time) preset for each of the a plurality of unmanned moving devices.

Further, in particular, according to the live video distribution method of the eighth aspect of the present invention and the video distribution device used in the live video distribution method of the aspect, by deploying the unmanned moving device to various tourist destinations in different countries, the user can freely select the tourist destination and enjoy the live video of the tourist destination. Therefore, the user can freely select a tourist spot and enjoy the live video of the tourist spot. This allows users to, for example, enjoy live video of the Parthenon in Greece and then live video of the Egyptian pyramids while in Tokyo.

Further, in particular, according to the live video distribution method of the ninth aspect of the present invention and the video distribution device used in the live video distribution method of the aspect, it is possible that “an image of a visual field range adapted to the movement of the user's head or eyeball” is cut out and displayed by moving the head and eyeballs of the user, or “the image of the display range that the user wants to display by the display means of the user device” is displayed by operating the user device.

Further, in particular, according to the video distribution device of the twentieth aspect of the present invention, the wide-angle video signal and the predetermined display range video signal can be switched and transmitted according to the user device. For example, a predetermined display range video signal is transmitted to a user device whose display means is a flat display, and a spherical 3D video signal or hemispherical 3D video is transmitted to a user device whose display means is an HMD. Further, when the live video distribution method of the present invention is used for commercial purposes, only the predetermined display range video signal is transmitted to the user device used by the user who uses the free service, and a spherical video signal or an hemispherical video signal is transmitted to a user device used by a user who uses a paid service.

Further, in particular, according to the live video distribution method according to the tenth aspect of the present invention and the video distribution device used in the live video distribution method according to the aspect, sound emitted by an operator or a navigator other than the operator can be emitted from the sound emitting means of the user device used by each user. For this reason, even if the operator or navigator is remote from each user, it is possible to explain in real time the target being shooted by the unmanned moving device, as if it were a tour conductor of a group tour.

Further, in particular, according to the live video distribution method of the eleventh aspect of the present invention and the video distribution device used in the live video distribution method of the aspect, the sound superimposed with voice emitted by the users, who enjoy the video of a live video signal based on the result of shooting the shooting target by the image capturing means of the same unmanned moving device, is emitted from the sound emitting means of the user device used by each user. For this reason, even if each user is remote from each other, they can share their thoughts on the target being shooted by the unmanned moving device, as if they were on the same group tour.

Further, in particular, according to the video archive device that stores the video distribution device of the twenty-third aspect of the present invention and the video data file generated by the video distribution device of the aspect, even a user who could not enjoy the video of the live video signal in real time at the time of live streaming can also enjoy the recorded video by playing the video data file, since the video data transmitted by the live video signal is recorded as a video data file.

### BRIEF DESCRIPTION OF DRAWINGS

FIG. 1 is a schematic view illustrating the configuration and function of a live video distribution system that realizes a live video distribution method according to Embodiment 1 of the present invention, and the function of a video distribution device used in the live video distribution method;

FIG. 2 is a schematic view illustrating the configuration and function of a live video distribution system that realizes a live video distribution method according to Embodiment 2 of the present invention, and the function of a video distribution device used in the live video distribution method;

FIG. 3 is a schematic view illustrating the configuration and function of a live video distribution system that realizes a live video distribution method according to Embodiment 3 of the present invention, and the function of a video distribution device used in the live video distribution method;

FIG. 4 is a schematic view illustrating the configuration and function of a live video distribution system that realizes a live video distribution method according to Embodiment 4 of the present invention, and the function of a video distribution device and a video archive device used in the live video distribution method;

FIG. 5 is a schematic view illustrating the configuration and function of a live video distribution system that realizes a live video distribution method according to

Embodiment 5 of the present invention, and the function of a video distribution device and a video archive device used in the live video distribution method;

FIG. 6 is a schematic view illustrating the configuration and function of a live video distribution system that realizes a live video distribution method according to Embodiment 6 of the present invention, and the function of a video distribution device and a video archive device used in the live video distribution method;

FIG. 7 is a schematic view illustrating the configuration and function of a live video distribution system that realizes a live video distribution method according to Embodiment 7 of the present invention, and the function of a video distribution device and a video archive device used in the live video distribution method;

FIG. 8 is a schematic view illustrating the configuration and function of a live video distribution system that realizes a live video distribution method according to Embodiment 8 of the present invention, and the function of a video distribution device and a video archive device used in the live video distribution method;

FIG. 9 is a schematic view illustrating the configuration and function of a live video distribution system that realizes a live video distribution method according to Embodiment 9 of the present invention, and the function of a video distribution device and a video archive device used in the live video distribution method;

FIG. 10 is a schematic view illustrating the configuration and function of a live video distribution system that realizes a live video distribution method according to Embodiment 10 of the present invention, and the function of a video distribution device and a video archive device used in the live video distribution method;

FIG. 11 is a schematic view illustrating the configuration and function of a live video distribution system that realizes a live video distribution method according to Embodiment 11 of the present invention, and the function of a video distribution device and a video archive device used in the live video distribution method;

FIG. 12 is a schematic view illustrating the configuration and function of a live video distribution system that realizes a live video distribution method according to

Embodiment 12 of the present invention, and the function of a video distribution device and a video archive device used in the live video distribution method;

FIG. 13 is a schematic view illustrating the configuration and function of a live video distribution system and an on-the-spot system that realize a live video distribution method according to Embodiment 13 of the present invention, and the function of a video distribution device and a video archive device used in the live video distribution method;

FIG. 14 is a schematic view illustrating the configuration and function of a live video distribution system and an on-the-spot system that realize a live video distribution method according to Embodiment 14 of the present invention, and the function of a video distribution device and a video archive device used in the live video distribution method;

FIG. 15 is a schematic view illustrating the configuration and function of a live video distribution system and an on-the-spot system that realize a live video distribution method according to Embodiment 15 of the present invention, and the function of a video distribution device and a video archive device used in the live video distribution method;

FIG. 16 is a schematic view illustrating the configuration and function of a live video distribution system and an on-the-spot system that realize a live video distribution method according to Embodiment 16 of the present invention, and the function of a video distribution device and a video archive device used in the live video distribution method;

FIG. 17 is a schematic view illustrating the configuration and function of a live video distribution system and an on-the-spot system that realize a live video distribution method according to Embodiment 17 of the present invention, and the function of a video distribution device and a video archive device used in the live video distribution method;

FIG. 18 is a schematic view illustrating the configuration and function of a live video distribution system and an on-the-spot system that realize a live video distribution method according to Embodiment 18 of the present invention, and the function of a video distribution device and a video archive device used in the live video distribution method;

FIG. 19 is a schematic view illustrating the configuration and function of a live video distribution system that realizes a live video distribution method according to Embodiment 19 of the present invention, and the function of a video distribution device and a video archive device used in the live video distribution method;

FIG. 20 is a schematic view illustrating the configuration and function of a live video distribution system that realizes a live video distribution method according to Embodiment 20 of the present invention, and the function of a video distribution device and a video archive device used in the live video distribution method;

FIG. 21 is a schematic view illustrating the configuration and function of a live video distribution system that realizes a live video distribution method according to Embodiment 21 of the present invention, and the function of a video distribution device and a video archive device used in the live video distribution method;

FIG. 22 is a schematic view illustrating the configuration and function of a live video distribution system that realizes a live video distribution method according to

Embodiment 22 of the present invention, and the function of a video distribution device and a video archive device used in the live video distribution method;

FIG. 23 is a schematic view illustrating the configuration and function of a live video distribution system that realizes a live video distribution method according to Embodiment 23 of the present invention, and the function of a video distribution device and a video archive device used in the live video distribution method;

FIG. 24 is a schematic view illustrating the configuration and function of a live video distribution system and an on-the-spot system that realize a live video distribution method according to Embodiment 24 of the present invention, and the functions of a video distribution device and a video archive device used in the live video distribution method.;

FIG. 25 is a display image diagram illustrating the screen displayed on the user device used in the live video distribution method according to Embodiment 24 of the present invention;

FIG. 26 is a display image diagram illustrating the screen displayed on the user device used in the live video distribution method according to Embodiment 24 of the present invention;

FIG. 27 is a schematic view illustrating The configuration and function of a live video distribution system and an on-the-spot system that realize a live video distribution method according to Embodiment 25 of the present invention, and the functions of a video distribution device and a video archive device used in the live video distribution method;

FIG. 28 is a schematic view illustrating the viewpoint and the line of sight of the aerial shoot drone constituting the on-the-spot system that realizes the live video distribution method according to the Embodiment 25 of the present invention.;

FIG. 29 is a display image diagram illustrating the screen displayed on the user device used in the live video distribution method according to Embodiment 25 of the present invention;

FIG. 30 is a schematic view illustrating the image capturing range, vantage point, line of sight and viewpoint (center of image capturing range) of an image capturing means;

### DESCRIPTION OF EMBODIMENTS

Embodiments of the present invention will be described below with reference to the drawings. However, the present invention is not limited to those embodiments, but various changes may be made within the scope of the technical idea of the present invention.

### Embodiment 1

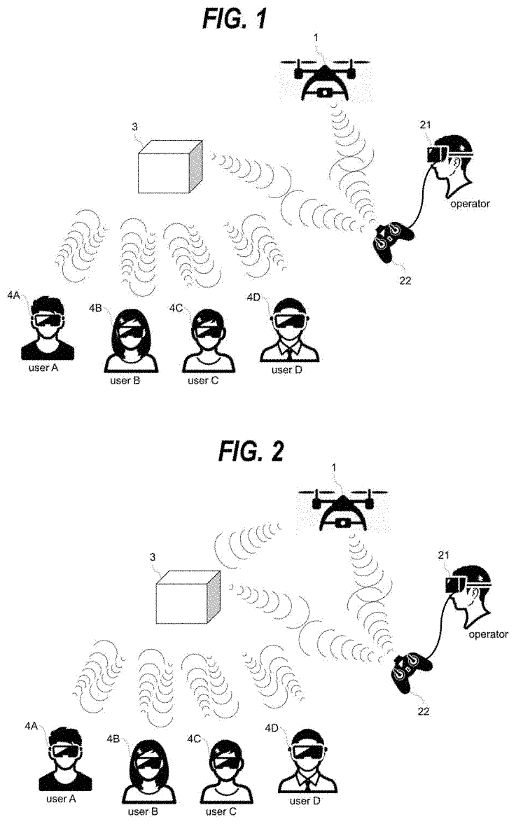

FIG. 1 is a schematic view illustrating the configuration and function of a live video distribution system that realizes a live video distribution method according to Embodiment 1 of the present invention, and the function of a video distribution device used in the live video distribution method.

The live video distribution system of this embodiment comprises an aerial shoot drone 1, an HMD for operator 21 used by operator, a drone controller 22 used by operator (hereinafter, the HMD for operator 21 and the drone controller 22 are collectively referred to as “operator device 2”.), a video distribution device 3, and an HMD for user A_4A to an HMD for user D_4D which is used by users A to D, respectively.

In each of the HMD for operator 21 and the HMD for user A_4A to HMD for user D_4D, the microphone and the microphone are integrally configured. Further, the drone controller 22 has a wireless communication means, and the HMD for operator 21 and the drone controller 22 are connected by wire with a communication cable. In such a configuration, the HMD for operator 21 transmits and receives signals to and from the aerial shoot drone 1 and the video distribution device 3 via the wireless communication means of the drone controller 22. On the other hand, the HMD for user A_4A to HMD for user D_4D themselves have a wireless communication means, and transmit and receive signals to and from the video distribution device 3 by their own wireless communication means.

Further, in this embodiment, the number of users who use the live video distribution system is four, users A to D, but the number of users can be increased to any number in principle.

The aerial shoot drone 1 is a multicopter type unmanned aerial vehicle that floats in the sky above the area where shooting targets exist such as a tourist spot and performs straight-ahead movements, turning movements, rotational movements, etc., by controlling the rotation speed of each rotor.

In addition, the aerial shoot drone 1 is equipped with two spherical cameras that cover a 360-degree viewing angle (solid angle) as image capturing means, and shoots a shooting target in the area from the sky. Further, a spherical 3D live video signal based on the results captured by the two spherical cameras is generated, and the spherical 3D live video signal is wirelessly transmitted to the drone controller 22. Further, the aerial shoot drone 1 generates a spherical 3D live video signal based on the results captured by the two spherical cameras, and wirelessly transmits the spherical 3D live video signal to the drone controller 22.

The drone controller 22 transmits the received spherical 3D live video signal to the HMD for operator 21 via a communication cable, while wirelessly transmitting it to the video distribution device 3.

The HMD for operator 21 is equipped with a sensor that detects the movement of the operator's head and eyeball, and the HMD for operator 21 projects the video of the live video signal from the left and right projection units based on the received spherical 3D live video signal and the detection result of the sensor. As a result, the operator can see the predetermined display range video of the spherical 3D live video signal corresponding to the movement of his/her head and eyeball.

The operator operates the drone controller 22 while observing the predetermined display range of the spherical 3D live video signal projected from the left and right projection units of the HMD for operator 21. The drone controller 22 is a radio-type joystick controller that generates a flight control signal based on the lever operation and dial operation of the operator, and wirelessly transmits the flight control signal to the aerial shoot drone 1. The number of revolutions of the rotor of the aerial shoot drone 1 is controlled based on the received flight control signal, and the aerial shoot drone 1 flies as intended by the operator.

On the other hand, each of the HMD for user A_4A to HMD for user D_4D also has a sensor for detecting the movement of the head and eyeballs of the users A to D. And the HMD for user A_4A to HMD for user D_4D generate a signal for setting the display range of the image projected from the left and right projection units (hereinafter abbreviated as “display range setting signal”) based on the detection result of each sensor and wirelessly transmit the display range setting signal to the video distribution device 3.

The video distribution device 3 generates a 3D live video signal to be transmitted to each of the HMD for user A_4A to HMD for user D_4D from the spherical 3D live video signal received from the drone controller 22 based on the display range setting signal received from each of the HMD for user A_4A to HMD for user D_4D and wirelessly transmits the 3D live video signal to each of the HMD for user A_4A to HMD for user D_4D.

Each of the HMD for user A_4A to HMD for user D_4D projects an image from the left and right projection units based on the 3D live video signal received from the video distribution device 3. As a result, the users A to D can see the predetermined display range video of the 3D live video signal corresponding to the movement of their head and eyeball. In this way, the users A to D can enjoy the predetermined display range of the spherical 3D live video signal of the target shooted by the spherical camera of the aerial shoot drone 1 without performing any maneuvering by themselves.

In this embodiment, the video distribution device 3 is configured to cut out a predetermined display range image based on the display range setting signals received from each of the HMD for user A_4A to HMD for user D_4D, but it is also possible to transmit a spherical 3D live video signal from the video distribution device 3 and cut out a predetermined display range image in the HMD for user A_4A to HMD for user D_4D based on the received spherical 3D live video signal and the detection result of the sensor.

In addition, the operator will verbally explain the target shooted by the spherical camera of the aerial shoot drone 1 while watching the video of the spherical 3D live video signal projected from the left and right projection units of the HMD for operator 21. The sound emitted by the operator is collected by a microphone integrated with the HMD for operator 21, and wirelessly transmitted as an audio signal to the video distribution device 3 via the drone controller 22.

In this embodiment, the target shooted by the operator is explained by the operator himself/herself, but it is also possible to provide a navigator separately from the operator so that the navigator will explain. At that time, the navigator wears an HMD with a microphone similar to the HMD for operator 21 on the head, and gives an oral explanation while watching the video of the live video signal projected from the left and right projection units on the HMD. The sound emitted by the navigator is collected by a microphone integrally provided in the HMD, and is wirelessly transmitted to the video distribution device 3 as a voice signal via the drone controller 22.

Further, each of the users A to D dictates his/her impression about the target shooted by the spherical camera of the aerial shoot drone 1, while watching the predetermined display range video of the 3D live video signal projected from the left and right projection units of the HMD for user A_4A to HMD for user D_4D. The sound emitted by each of the users A to D is collected by the microphone integrally provided in the HMD for user A_4A to HMD for user D_4D, and is wirelessly transmitted to the video distribution device 3 as an audio signal.

The video distribution device 3 generates the following four types of superimposed audio signals based on the audio signals generated and transmitted by the microphones integrally provided in the HMD for operator 21 and the HMD for user A_4A to HMD for user D_4D (in the following, “audio signal generated/transmitted by the microphone of the HMD for operator 21” and “audio signal generated/transmitted by the microphone of the HMD for user A_4A to the HMD for user D_4D” are abbreviated as “operator audio signal” and “user A audio signal to user D audio signal”, respectively.) and transmits the superimposed audio signals A to D to each of the HMD for user A_4A to HMD for user D_4D, respectively. superimposed audio signal A an audio signal in which the operator audio signal, the user B audio signal, the user C audio signal and the user D audio signal are superimposed superimposed audio signal B an audio signal in which the operator audio signal, the user A audio signal, the user C audio signal and the user D audio signal are superimposed superimposed audio signal C an audio signal in which the operator audio signal, the user A audio signal, the user B audio signal and the user D audio signal are superimposed superimposed audio signal D an audio signal in which the operator audio signal, the user A audio signal, the user B audio signal and the user C audio signal are superimposed

In addition, the video distribution device 3 generates the following superimposed audio signal 0 and transmits it to the HMD for operator 21. superimposed audio signal 0 . . . an audio signal in which the user A audio signal, the user B audio signal, the user C audio signal and the user D audio signal are superimposed The HMD for operator 21 receives the superimposed audio signal 0 from the video distribution device 3 via the drone controller 22.

On the other hand, each of the microspeakers integrally provided in the HMD for operator 21 and the HMD for user A_4A to HMD for user D_4D emits sound based on the received superimposed audio signal. As a result, each of the operator and the users A to D can hear the voice superimposed with the voice emitted by a person other than himself/herself. In particular, users A to D can hear explanations given verbally by the operator (or navigator) and impressions dictated by users other than themselves. In addition, since the operator can hear the impressions dictated by the users A to D, the flight of the aerial shoot drone 1 can be adjusted or the commentary can be supplemented according to the impressions.

Further, the video distribution device 3 writes the video data and audio data transmitted by the 3D live video signal and the superimposed audio signal 0 to the storage means provided by the video distribution device 3 as temporary data substantially at the same time when the transmission of the 3D live video signal and the superimposed audio signal 0 is started. Further, substantially at the same time when the transmission of the 3D live video signal and the superimposed audio signal 0 is completed, a video/audio data file in a format such as MP4 is created from the temporary data and stored in the storage means.

In this embodiment, the HMD for operator 21 is configured to transmit and receive all-sky 3D video signals and audio signals via the drone controller 22, but it can also be configured to have a wireless communication means and receive directly to and from the aerial shoot drone 1 and the video distribution device 3.

### Embodiment 2

FIG. 2 is a schematic view illustrating the configuration and function of a live video distribution system that realizes a live video distribution method according to Embodiment 2 of the present invention, and the function of a video distribution device used in the live video distribution method.

The functions of the components of the live video distribution system of this embodiment (aerial shoot drone 1, HMD for operator 21, drone controller 22, video distribution device 3, HMD for user A_4A to HMD for user D_4D) are the same as those of the Embodiment 1 except for the points described in the next paragraph.

In this embodiment, the spherical 3D live video signal is transmitted from the aerial shoot drone 1 to the video distribution device 3 by direct wireless transmission, not via the drone controller 22.

### Embodiment 3

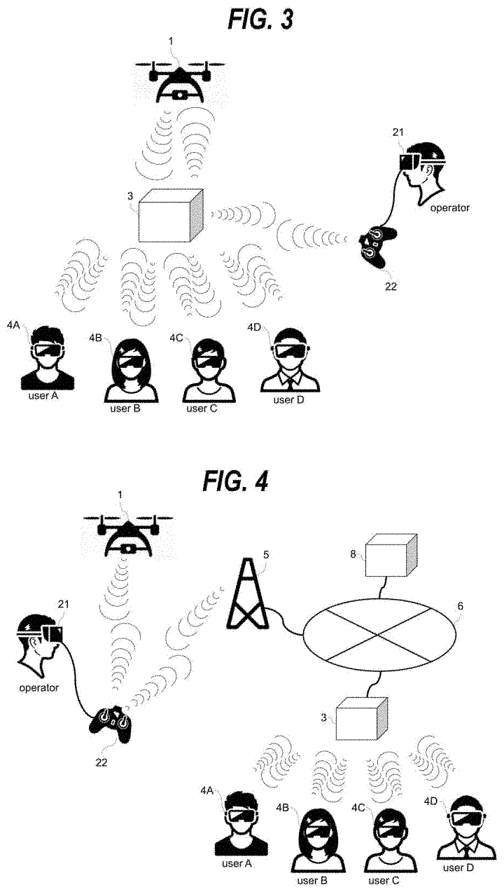

FIG. 3 is a schematic view illustrating the configuration and function of a live video distribution system that realizes a live video distribution method according to Embodiment 3 of the present invention, and the function of a video distribution device used in the live video distribution method.

The functions of the components of the live video distribution system of this embodiment (aerial shoot drone 1, HMD for operator 21, drone controller 22, video distribution device 3, HMD for user A_4A to HMD for user D_4D) are the same as those of the Embodiment 1 except for the points described up to paragraph [0101].

In this embodiment, the signal transmission/reception between the aerial shoot drone 1 and the drone controller 22 is not performed by direct wireless communication, but is performed via the video distribution device 3.

That is, the video distribution device 3 wirelessly transmits the spherical 3D live video signal received from the aerial shoot drone 1 to the drone controller 22.

Further, the drone controller 22 generates a flight control signal based on the lever operation and dial operation of the operator, and wirelessly transmits the flight control signal to the video distribution device 3. The video distribution device 3 wirelessly transmits the flight control signal received from the drone controller 22 to the aerial shoot drone 1 after performing necessary processing. The number of revolutions of the rotor of the aerial shoot drone 1 is controlled based on the received flight control signal, and the aerial shoot drone 1 flies as intended by the operator.

### Embodiment 4

FIG. 4 is a schematic view illustrating the configuration and function of a live video distribution system that realizes a live video distribution method according to Embodiment 4 of the present invention, and the function of a video distribution device and a video archive device used in the live video distribution method.

The live video distribution system of this embodiment includes the aerial shoot drone 1, the HMD for operator 21, the drone controller 22, the video distribution device 3, and the HMD for user A_4A to HMD for user D_4D, as well as a video archive device 8. The functions of these components are the same as those of the Embodiment 1 except for the points described up to paragraph [0107].

In this embodiment, the transmission and reception of the signal between the drone controller 22 and the video distribution device 3 is not performed by direct wireless communication, but is performed via a public network.

That is, the drone controller 22 transmits the spherical 3D live video signal received from the aerial shoot drone 1 to a 5G base station 5, which is the base station of the 5G network, and the spherical 3D live video signal is transmitted to the video distribution device 3 via a 5G network (not shown in FIG. 4) and the intemet 6.

In addition, the drone controller 22 transmits an audio signal generated based on the result of sound collection by the microphone integrated with the HMD for operator 21 to the 5G base station 5, and then the audio signal is transmitted to the video distribution device 3 via the intern& 6, the 5G network and the intern& 6. On the other hand, the superimposed audio signal 0 generated by the video distribution device 3 is transmitted to the drone controller 22 via the route of the interne 6→5G network→5G base station 5, and finally transmitted to the HMD for operator 21.

Further, the video distribution device 3 writes the video data and audio data transmitted by the 3D live video signal and the superimposed audio signal 0 as temporary data to the storage means provided by the video distribution device 3 substantially at the same time when the transmission of the 3D live video signal and the superimposed audio signal 0 is started. Further, substantially at the same time when the transmission of the 3D live video signal and the superimposed audio signal 0 is completed, a video/audio data file in a format such as MP4 is created from the temporary data, and the video data file is transmitted to the video archive device 8. And the video archive device 8 saves the transmitted video data file.

In this embodiment, the drone controller 22 is configured to have a 5G communication function, but a 5G communication unit (5G compatible Wi-Fi router, etc.)

may be separately provided and the drone controller 22 may be configured to communicate with the 5G communication unit by wire or wirelessly.

Further, in this embodiment, the video archive device 8 is provided as a device separate from the video distribution device 3, but the video distribution device 3 itself may be configured to store the video data file (that is, the video distribution device 3 and the video archive device 8 are integrally configured).

Further, in Embodiment 6 and the embodiment described in the previous paragraph, the video archive device 8 is configured to store the video/audio data file transmitted from the video distribution device 3, but a configuration in that the aerial shoot drone is equipped with a video data recording device and records the video shooted by the image capturing means in the video data recording device is possible. And in such a configuration video data is collected as a video data file and is stored the video data file in the video archive device 8 after the aerial shoot drone 1 returns from the flight. By adopting such a configuration, it is possible to store high-quality video and distribute the high-quality video of the saved video data file to the user device without being restricted by the capacity of wireless communication.

### Embodiment 5

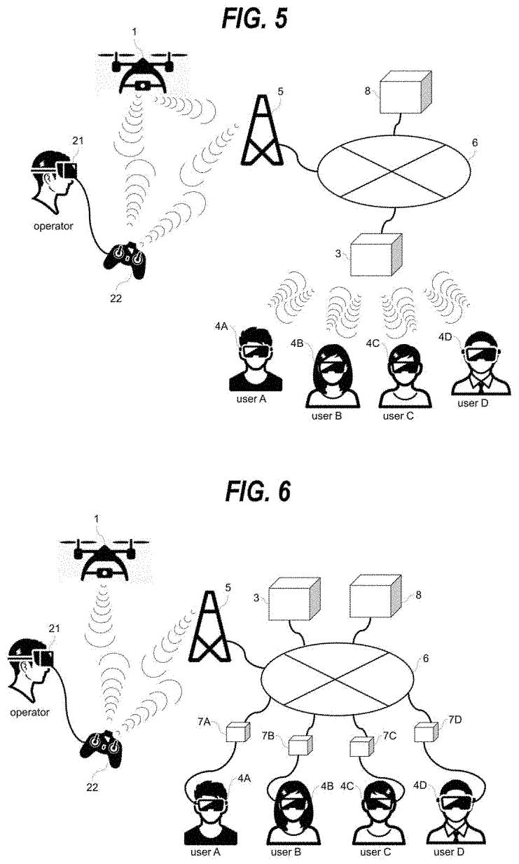

FIG. 5 is a schematic view illustrating the configuration and function of a live video distribution system that realizes a live video distribution method according to Embodiment 5 of the present invention, and the function of a video distribution device and a video archive device used in the live video distribution method.

The functions of the components of the live video distribution system of this embodiment (aerial shoot drone 1, HMD for operator 21, drone controller 22, video distribution device 3, HMD for user A_4A to HMD for user D_4D, video archive device 8) are the same as those of the Embodiment 4 except for the points described in the next paragraph.

In this embodiment, the spherical 3D live video signal is transmitted from the aerial shoot drone 1 to the video distribution device 3 without going through the drone controller 22. That is, the aerial shoot drone 1 transmits a spherical 3D live video signal to the 5G base station 5, which is a base station of the 5G network, and the spherical 3D live video signal is transmitted to the video distribution device 3 via the 5G network (not shown in FIG. 5) and the intemet 6.

### Embodiment 6

FIG. 6 is a schematic view illustrating the configuration and function of a live video distribution system that realizes a live video distribution method according to Embodiment 6 of the present invention, and the function of a video distribution device and a video archive device used in the live video distribution method.

The functions of the components of the live video distribution system of this embodiment (aerial shoot drone 1, HMD for operator 21, drone controller 22, video distribution device 3, HMD for user A_4A to HMD for user D_4D, video archive device 8) are the same as those of the Embodiment 1 except for the points described up to paragraph [0119].

In this embodiment, the signal transmission/reception between the video distribution device 3 and the HMD for user A_4A to HMD for user D_4D is not performed by direct wireless communication, but is performed via a public network.

That is, each of the HMD for user A_4A to HMD for user D_4D transmits a display range setting signal generated based on the detection result of the sensor that detects the movement of the head and eyeballs of users A to D to the video distribution device 3 via each of an ISP server A_7A to an ISP server D_7D and the intemet 6.

The video distribution device 3 transmits a 3D live video signal ,which is generated based on the display range setting signal received from each of the HMD for user A_4A to HMD for user D_4D and the spherical 3D live video signal received from the aerial shoot drone 1, to each of the HMD for user A_4A to HMD for user D_4D via the internet 6 and each of the ISP server A_7A to ISP server D_7D.

In addition, each of the HMD for user A_4A to HMD for user D_4D transmits an audio signal generated based on the result of sound collection by the integrally configured microphone to the video distribution device 3 via each of the ISP server A_7A to ISP server D_7D and the internet 6. On the other hand, the superimposed audio signals A to D generated by the video distribution device 3 are transmitted to each of the HMD for user A_4A to HMD for user D_4D via the internet 6 and each of the ISP server A_7A to ISP server D_7D.

### Embodiment 7

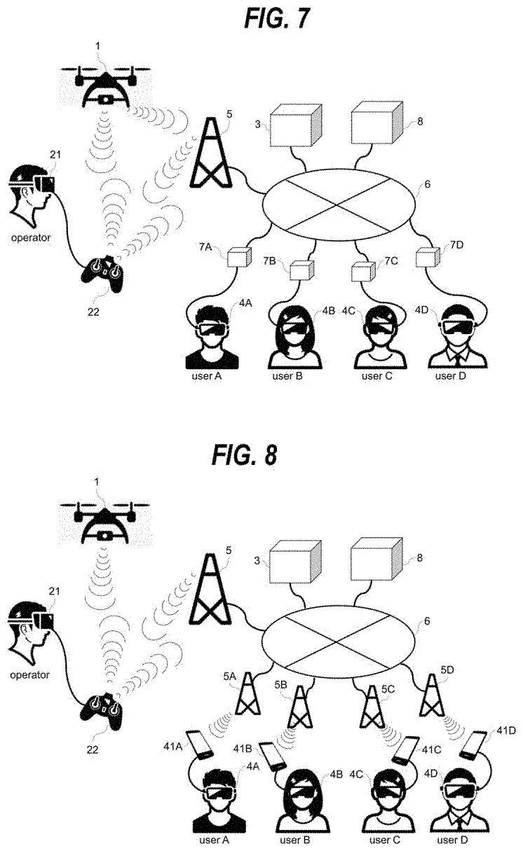

FIG. 7 is a schematic view illustrating the configuration and function of a live video distribution system that realizes a live video distribution method according to Embodiment 7 of the present invention, and the function of a video distribution device and a video archive device used in the live video distribution method.

The functions of the components of the live video distribution system of this embodiment (aerial shoot drone 1, HMD for operator 21, drone controller 22, video distribution device 3, HMD for user A_4A to HMD for user D_4D, video archive device 8) are the same as those of the Embodiment 5 except for the points described in the next paragraph.

In this embodiment, the signal transmission/reception between the video distribution device 3 and the HMD for user A_4A to HMD for user D_4D is not performed by direct wireless communication, but is performed via a public network.

### Embodiment 8

FIG. 8 is a schematic view illustrating the configuration and function of a live video distribution system that realizes a live video distribution method according to Embodiment 8 of the present invention, and the function of a video distribution device and a video archive device used in the live video distribution method.

The functions of the components of the live video distribution system of this embodiment (aerial shoot drone 1, HMD for operator 21, drone controller 22, video distribution device 3, HMD for user A_4A to HMD for user D_4D, video archive device 8) are the same as those of the Embodiment 6 except for the points described up to paragraph [0129].

In this embodiment, the device for user A to device for user D is composed of a smartphone for user A_41A to a smartphone for user D_41D in addition to the HMD for user A_4A to HMD for user D_4D, and the HMD for user A_4A to HMD for user D_4D are connected to the smartphone for user A_41A to smartphone for user D_41D by wire with a communication cable, respectively.

The smartphone for user A_41A to smartphone for user D_41D have a 5G communication function. Each of the HMD for user A_4A to HMD for user D_4D does not transmit and receive signals to and from each of the ISP server A_7A to ISP server D_7D, but transmits and receives signals to and from each of the 5G base station A_5A to 5G base station C_5C and 5G base station D_5D via the smartphone for user A_41A to smartphone for user D_41D.

That is, each of the HMD for user A_4A to HMD for user D_4D transmits a display range setting signal generated based on the detection result of the sensor that detects the movement of the head and eyeball of users A to D to the video distribution device 3 via each of the smartphone for user A_41A to smartphone for user D_41D, each of the 5G base station A_5A to 5G base station D_5D, 5G network and the internet 6.

The video distribution device 3 transmits a 3D live video signal generated based on the display range setting signal received from each of the HMD for user A_4A to HMD for user D_4D and the spherical 3D live video signal received from the aerial shoot drone 1 to each of the HMD for user A_4A to HMD for user D_4D via the internet 6, 5G networks, each of the 5G base station A_5A to 5G base station D_5D and each of the smartphone for user A_41A to smartphone for user D_41D.

In addition, each of the HMD for user A_4A to HMD for user D_4D transmits an audio signal generated based on the result of sound collection by an integrally configured microphone to the video distribution device 3 via each of the smartphone for user A_41A to smartphone for user D_41D, each of the 5G base station A_5A to 5G base station D_5D, 5G network and the internet 6. On the other hand, the superimposed audio signals A to D generated by the video distribution device 3 are transmitted to the HMD for user A_4A to HMD for user D_4E via the internet 6, 5G networks, each of the 5G base station A_5A to 5G base station D_5D and each of the smartphone for user A_41A to smartphone for user D_41D.

### Embodiment 9

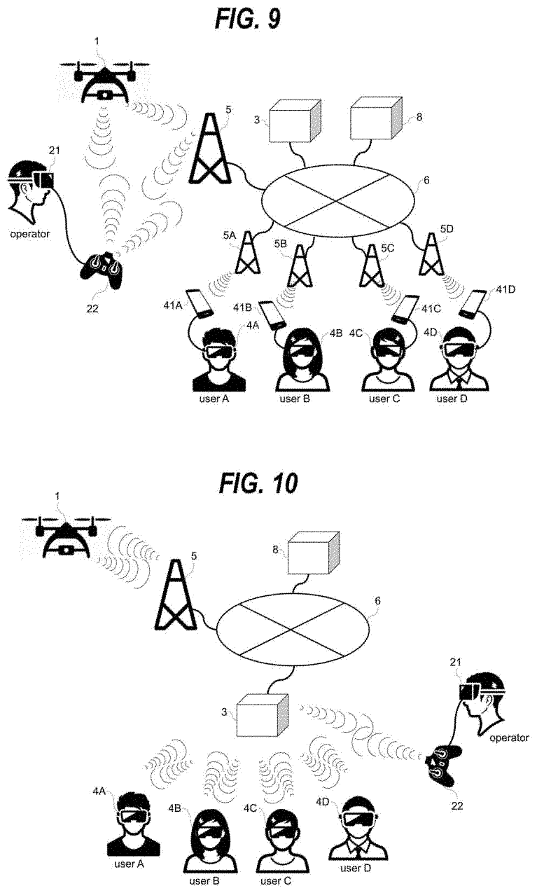

FIG. 9 is a schematic view illustrating the configuration and function of a live video distribution system that realizes a live video distribution method according to Embodiment 9 of the present invention, and the function of a video distribution device and a video archive device used in the live video distribution method.

The functions of the components of the live video distribution system of this embodiment (aerial shoot drone 1, HMD for operator 21, drone controller 22, video distribution device 3, HMD for user A_4A to HMD for user D_4D, video archive device 8) are the same as those of the Embodiment 6 except for the points described up to paragraph [0133].

In this embodiment, the devices for user A to the devices for user D are composed of the smartphone for user A_41A to smartphone for user D_41D in addition to the HMD for user A_4A to HMD for user D_4D, and the HMD for user A_4A to HMD for user D_4D are connected to the smartphone for user A_41A to smartphone for user D_41D by wire with a communication cable, respectively.

The smartphone for user A_41A to smartphone for user D_41D have a 5G communication function. Each of the HMD for user A_4A to HMD for user D_4D does not transmit and receive signals to and from each of the ISP server A_7A to ISP server D_7D, but transmits and receives signals to and from each of the 5G base station A_5A to 5G base station D_5D via each of the smartphone for user A_41A to smartphone for user D_41D, respectively.

### Embodiment 10

FIG. 10 is a schematic view illustrating the configuration and function of a live video distribution system that realizes a live video distribution method according to Embodiment 10 of the present invention, and the function of a video distribution device and a video archive device used in the live video distribution method.

The functions of the components of the live video distribution system of this embodiment (aerial shoot drone 1, HMD for operator 21, drone controller 22, video distribution device 3, HMD for user A_4A to HMD for user D_4D, video archive device 8) are the same as those of the Embodiment 5 except for the points described up to paragraph [0139].

In this embodiment, the signal transmission/reception between the aerial shoot drone 1 and the drone controller 22 is not performed by direct wireless communication, but is performed via the video distribution device 3 and the public network. In addition, the audio signal is transmitted and received between the HMD for operator 21 and the video distribution device 3 by direct wireless communication without going through a public network.

That is, the video distribution device 3 wirelessly transmits the spherical 3D live video signal received from the aerial shoot drone 1 via the 5G base station 5→5G network→the intemet 6 to the drone controller 22.

Further, the drone controller 22 generates a flight control signal based on the lever operation and dial operation of the operator, and wirelessly transmits the flight control signal to the video distribution device 3. The video distribution device 3 transmits the flight control signal received from the drone controller 22 to the aerial shoot drone 1 from the 5G base station 5 via the intemet 6 and the 5G network after performing the necessary processing.

In addition, the drone controller 22 wirelessly transmits an audio signal generated based on the result of sound collection by the microphone integrated with the HMD for operator 21 to the video distribution device 3. On the other hand, the superimposed audio signal 0 generated by the video distribution device 3 is transmitted to the HMD for operator 21 via the drone controller 22.

### Embodiment 11

FIG. 11 is a schematic view illustrating the configuration and function of a live video distribution system that realizes a live video distribution method according to Embodiment 11 of the present invention, and the function of a video distribution device and a video archive device used in the live video distribution method.

The functions of the components of the live video distribution system of this embodiment (aerial shoot drone 1, HMD for operator 21, drone controller 22, video distribution device 3, HMD for user A_4A to HMD for user D_4D, video archive device 8) are the same as those of the Embodiment 10 except for the points described in the next paragraph.

In this embodiment, the aerial shoot drone 1 does not transmit and receive signals to and from only one 5G base station 5 (5G base station 5), but transmits and receives signals between a 5G base station I_51 to a 5G base station III_5111 in a cellular manner. In this embodiment, there are three 5G base stations, the 5G base station I 51 to 5G base station III_5111, but the number of 5G base stations can be increased in principle.

In this embodiment, with this configuration, the aerial shoot drone 1 can shoot shooting targets that spread over a wide area, since the aerial shoot drone 1 is not limited to the range where wireless communication is possible with only one 5G base station, and can fly anywhere within the range where cellular communication is possible.

### Embodiment 12

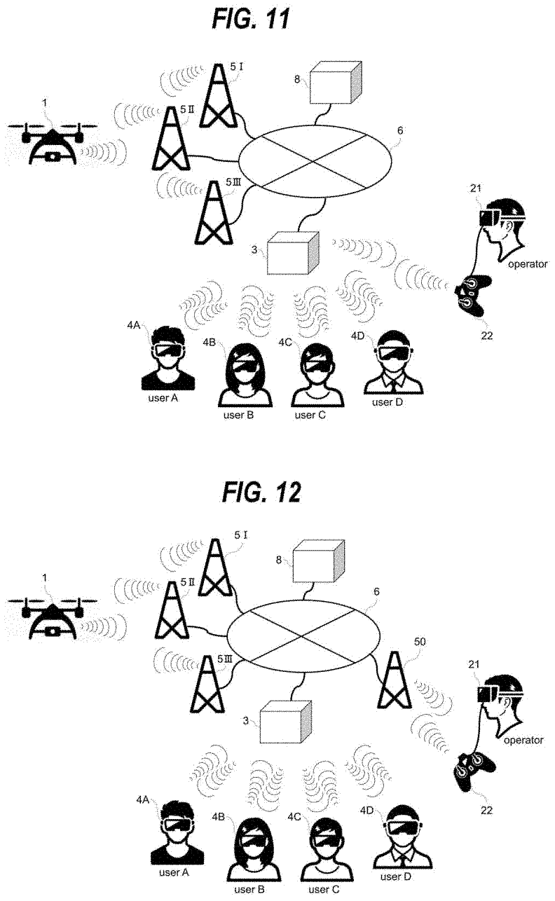

FIG. 12 is a schematic view illustrating the configuration and function of a live video distribution system that realizes a live video distribution method according to

Embodiment 12 of the present invention, and the function of a video distribution device and a video archive device used in the live video distribution method.

The functions of the components of the live video distribution system of this embodiment (aerial shoot drone 1, HMD for operator 21, drone controller 22, video distribution device 3, HMD for user A_4A to HMD for user D_4D, video archive device 8) are the same as those of the Embodiment 11 except for the points described up to paragraph [0149].

In this embodiment, the transmission/reception of the signal between the drone controller 22 and the video distribution device 3 is performed via a public network, not by direct wireless communication.

That is, the video distribution device 3 transmits the spherical 3D live video signal, which is received from the aerial shoot drone 1 via the 5G base station I_51 to 5G base station III 5111, 5G network and the internet 6, to the drone controller 22 from the 5G base station 50 via the internet 6 and the 5G network.

In addition, the drone controller 22 transmits the flight control signal generated based on the lever operation and dial operation of the operator to the 5G base station 50, and the flight control signal is transmitted to the video distribution device 3 via the 5G network and the internet 6.

In addition, the HMD for operator 21 transmits an audio signal generated based on the result of sound collection by the integrally configured microphone to the 5G base station 50 via the drone controller 22, and the audio signal is transmitted to the video distribution device 3 via the 5G network and the internet 6. On the other hand, the superimposed audio signal 0 generated by the video distribution device 3 is transmitted from the 5G base station 50 to the HMD for operator 21 via the internet 6 and the 5G network.

### Embodiment 13

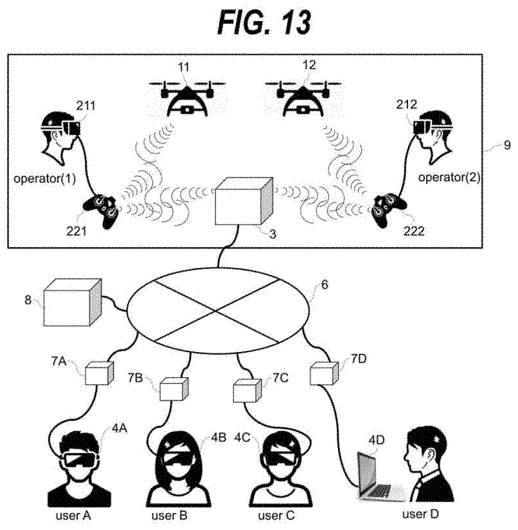

FIG. 13 is a schematic view illustrating the configuration and function of a live video distribution system and an on-the-spot system that realize a live video distribution method according to Embodiment 13 of the present invention, and the function of a video distribution device and a video archive device used in the live video distribution method.

The functions of the components of the live video distribution system of this embodiment (aerial shoot drone(1)_11, aerial shoot drone(2)_12, HMD for operator(1)_211, HMD for operator(2)_212, drone controller(1)_221, drone controller(2)_222, video distribution device 3, HMD for user A_4A to HMD for user C_4C, notebook PC for user D_4D, video archive device 8, on-the-spot system9) are the same as those of the Embodiment 1 except for the points described up to paragraph

The live video distribution system of this embodiment includes an aerial shoot drone(1)_11 and an aerial shoot drone(2)_12 as components. The aerial shoot drone(1)_11 flies based on the flight control signal generated and transmitted based on the operation of the drone controller(1)_221 by the operator (1), and the aerial shoot drone(2)_12 flies based on the flight control signal generated and transmitted based on the operation of the drone controller(2)_222 by the operator (2). In addition, the HMD for operator(1)_211 and the HMD for operator (2)_212 are equipped with sensors that detect the movement of the head and eyeballs of operator (1) and operator (2), respectively, and the HMD for operator(1)_211 projects the video of the live video signal from the left and right projection units based on the spherical 3D live video signal received from the aerial shoot drone(1)_11 and the detection result of the sensor, and the HMD for operator (2). 211 projects the video of the live video signal from the left and right projection units based on the spherical 3D live video signal received from the aerial shoot drone(2)_12 and the detection result of the sensor.

In this embodiment, there are two operators who operate the aerial shoot drone, operator (1) and operator (2), but the number of operators can be increased by any number in principle. In the following, “aerial shoot drone(1)_11, aerial shoot drone(2)_12, HMD for operator(1)_211, HMD for operator(2)_212, drone controller(1)_221, drone controller(2)_222, video distribution device 3” are collectively called on-the-spot system 9.

On the other hand, in this embodiment, there are four users, users A to C and user D, who use the live video distribution system, but only user D uses the notebook PC for user D_4D as the user device, not the HMD.

Then, users A to C and user D select which video of the live video signal shooted by the aerial shoot drone(1)_11 or the live video signal shooted by the aerial shoot drone(2)_12 is to be received, based on the profile of operator (1) and operator (2) and the flight plan (flight route and flight time) of the aerial shoot drone(1)_11 and the aerial shoot drone(2)_12, which are displayed in the virtual space projected by the HMD for user A_4A to HMD for user C_4C and on the display of notebook PC for user D_4D.

In order to make the selection described in the previous paragraph users A to C operate an operating means (not shown in FIG. 13) different from the HMD for user A_4A to HMD for user C_4C and user D operates the input means (keyboard and pointing device) of the notebook PC for user D_4D. And an unmanned moving device selection signal based on the selection result is transmitted to the video distribution device 3.

The video distribution device 3 associates the aerial shoot drone(1)_11 and the aerial shoot drone(2)_12 with the HMD for user A_4A to HMD for user C_4C and the notebook PC for user D_4D based on the received unmanned moving device selection signal. As a result of this mapping, the 3D live video signal generated from the spherical 3D live video signal received from the aerial shoot drone(1)_11 is transmitted to the HMD for user A_4A to HMD for user C_4C, and A two-dimensional live video signal generated from the spherical 3D live video signal received from the aerial shoot drone(2)_12 is transmitted to the notebook PC for user D_4D.

Further, in this embodiment, the transmission/reception of signals between the video distribution device 3 and the HMD for user A_4A to HMD for user C_4C and the notebook PC for user D_4D is not performed by direct wireless communication, but via a public network.

That is, each of the HMD for user A_4A to HMD for user C_4C transmits a display range setting signal generated based on the detection result of the sensor that detects the movement of the head and eyeball of users A to C to the video distribution device 3 via each of the ISP server A_7A to ISP server C_7C and the internet 6. On the other hand, the notebook PC for user D_4D transmits a display range setting signal generated by the user D by operating the input means of the notebook PC for user D_4D to the video distribution device 3 via the ISP server D_7D and the intemet 6.

The video distribution device 3 transmits a 3D live video signal generated based on the display range setting signal received from each of the HMD for user A_4A to HMD for user C_4C and the spherical 3D live video signal received from the aerial shoot drone(1)_11 to each of the HMD for user A_4A to HMD for user C_4C via the intemet 6 and each of the ISP server A_7A to ISP server C_7C. On the other hand, the video distribution device 3 transmits a two-dimensional live video signal generated based on the display range setting signal received from the notebook PC for user D_4D and the spherical 3D live video signal received from the aerial shoot drone(2)_12 to the notebook PC for user D_4D via the intemet 6 and ISP server D_7D.

In addition, each of the HMD for user A_4A to HMD for user C_4C and notebook PC for user D_4D transmits an audio signal generated based on the result of sound collection by an integrally configured microphone to video distribution device 3 via each of the ISP server A_7A to ISP server D_7D and the intemet 6. On the other hand, the superimposed audio signals A to D generated by the video distribution device 3 are transmitted to each of the HMD for user A_4A to HMD for user C_4C and the notebook PC for user D_4D via the intemet 6 and the ISP server A_7A to ISP server D_7D.

### Embodiment 14

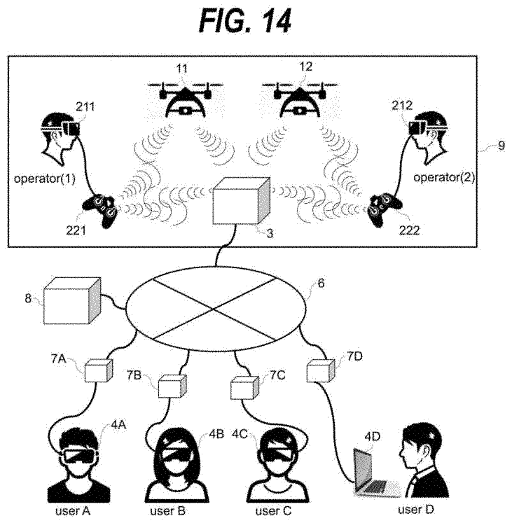

FIG. 14 is a schematic view illustrating the configuration and function of a live video distribution system and an on-the-spot system that realize a live video distribution method according to Embodiment 14 of the present invention, and the function of a video distribution device and a video archive device used in the live video distribution method.

The functions of the components of the live video distribution system of this embodiment (aerial shoot drone(1)_11, aerial shoot drone(2)_12, HMD for operator(1)_211, HMD for operator(2)_212, drone controller(1)_221 , drone controller(2)_222, video distribution device 3, HMD for user A_4A to HMD for user C_4C, notebook PC for user D_4D, video archive device 8, on-the-spot system 9) are the same as those of the Embodiment 13 except for the points described in the next paragraph.

In this embodiment, the transmission of the spherical 3D live video signal from the aerial shoot drone(1)_11 and the aerial shoot drone(2)_12 to the video distribution device 3 is performed by direct wireless transmission, not via the drone controller(1)_221 and the drone controller(2)_222.

### Embodiment 15

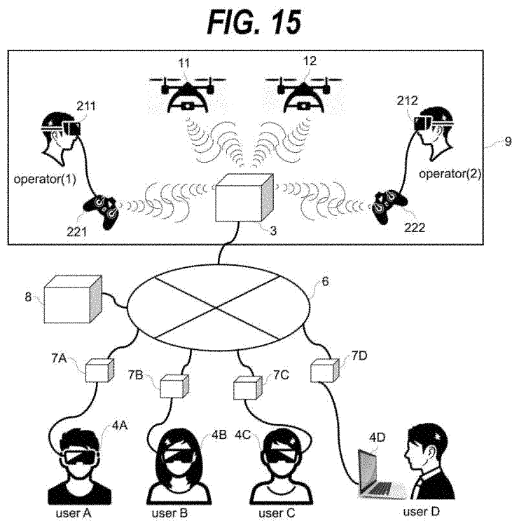

FIG. 15 is a schematic view illustrating the configuration and function of a live video distribution system and an on-the-spot system that realize a live video distribution method according to Embodiment 15 of the present invention, and the function of a video distribution device and a video archive device used in the live video distribution method.

The functions of the components of the live video distribution system of this embodiment (aerial shoot drone(1)_11, aerial shoot drone(2)_12, HMD for operator(1)_211, HMD for operator(2)_212, drone controller(1)_221 , drone controller(2)_222, video distribution device 3, HMD for user A_4A to HMD for user C_4C, notebook PC for user D_4D, video archive device 8, on-the-spot system 9) are the same as those of the Embodiment 14 except for the points described up to paragraph.

In this embodiment, the signal transmission/reception between aerial shoot drone(1)_11 and the drone controller(1)_221, and between the aerial shoot drone(2)_12 and the drone controller(2)_222 is not performed by direct wireless communication, but via the video distribution device 3.

That is, the video distribution device 3 wirelessly transmits the spherical 3D live video signals received from the aerial shoot drone(1)_11 and the aerial shoot drone(2)_12 to the drone controller(1)_221 and the drone controller(2)_222, respectively.

Further, the drone controller(1)_221 generates a flight control signal based on the lever operation and dial operation of the operator (1), and wirelessly transmits the flight control signal to the video distribution device 3. The video distribution device 3 wirelessly transmits the flight control signal received from the drone controller(1)_221 to the aerial shoot drone(1)_11 after performing necessary processing. The rotation speed of the rotor of the aerial shoot drone(1)_11 is controlled based on the received flight control signal, and the aerial shoot drone(1)_11 flies as intended by the operator (1). On the other hand, the drone controller(2)_222 generates a flight control signal based on the lever operation and dial operation of the operator (2), and wirelessly transmits the flight control signal to the video distribution device 3. The video distribution device 3 wirelessly transmits the flight control signal received from the drone controller(2)_222 to the aerial shoot drone(2)_12 after performing necessary processing. The rotation speed of the rotor blades of the aerial shoot drone(2)_12 is controlled based on the received flight control signal, and the aerial shoot drone(2)_12 flies as intended by operator (2).

### Embodiment 16

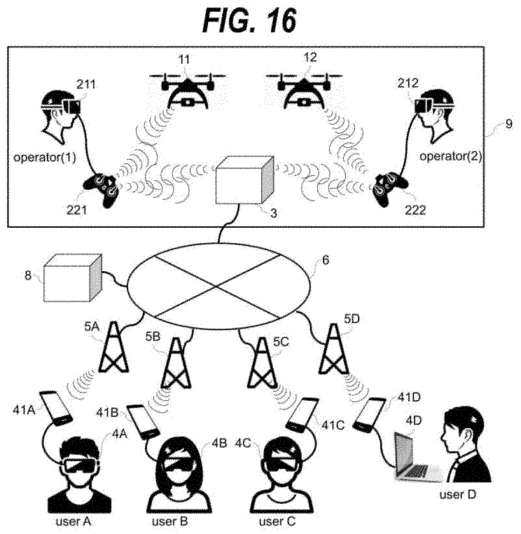

FIG. 16 is a schematic view illustrating the configuration and function of a live video distribution system and an on-the-spot system that realize a live video distribution method according to Embodiment 16 of the present invention, and the function of a video distribution device and a video archive device used in the live video distribution method.

The functions of the components of the live video distribution system of this embodiment (aerial shoot drone(1)_11, aerial shoot drone(2)_12, HMD for operator(1)_211, HMD for operator(2)_212, drone controller(1)_221 , drone controller(2)_222, video distribution device 3, HMD for user A_4A to HMD for user C_4C, notebook PC for user D_4D, smartphone for user A_41A to smartphone for user D_41D, video archive device 8, on-the-spot system 9) are the same as those of the Embodiment 13 except for the points described up to paragraph [0176].

In this embodiment, the device for user A to device for user C is composed of the smartphone for user A_41A to smartphone for user C_41C in addition to the HMD for user A_4A to HMD for user C_4C, and the device for user D is composed of the smartphone for user D_41D in addition to the notebook PC for user D_4D. The HMD for user A_4A to HMD for user C_4C and the notebook PC for user D_4D are connected to the smartphone for user A_41A to smartphone for user D_41D by wire with a communication cable, respectively.

The smartphone for user A_41A to smartphone for user D_41D have a 5G communication function. Each of the HMD for user A_4A to HMD for user C_4C and notebook PC for user D_4D does not transmit and receive signals to and from each of the ISP server A_7A to ISP server C_7 C and ISP server D_7D, respectively, but transmits and receives signals to and from each of the 5G base station A_5A to 5G base station C_5C and 5G base station D_5D via the smartphone for user A_41A to smartphone for user D_41D.

That is, each of the HMD for user A_4A to HMD for user C_4C transmits a display range setting signal generated based on the detection result of the sensor that detects the movement of the head and eyeball of users A to C to the video distribution device 3 via the smartphone for user A_41A to smartphone for user C_41C, the 5G base station A_5A to 5G base station C 5C, 5G network and the intemet 6. Further, the notebook PC for user D_4D transmits a display range setting signal generated by the user D by operating the input means of the notebook PC for user D_4D to the video distribution device 3 via the smartphone for user D_41D and the 5G base station D_5D, and 5G network and the intern& 6.

The video distribution device 3 transmits a 3D live video signal, which is generated based on the display range setting signal received from each of the HMD for user A_4A to HMD for user C_4C and the spherical 3D live video signal received from the aerial shoot drone(1)_11, to each of the HMD for user A_4A to HMD for user C_4C via the intern& 6, 5G networks, each of the 5G base station A_5A to 5G base station C_5C and each of the smartphone for user A_41A to smartphone for user C_41C. In addition, the video distribution device 3 transmits a t wo-dimensional live video signal, which is generated based on the display range setting signal received from notebook PC for user D_4D and the spherical 3D live video signal received from the aerial shoot drone(2)_12, to the notebook PC for user D_4D via the intemet 6, 5G networks, the 5G base station D_5D and the smartphone for user D_41D.

In addition, each of the HMD for user A_4A to HMD for user C_4C and notebook PC for user D_4D transmits an audio signal generated based on the result of sound collection by an integrally configured microphone to the video distribution device 3 via each of the smartphone for user A_41A to smartphone for user D_41D, each of the 5G base station A_5A to 5G base station D_5D, 5G network and the interne 6. On the other hand, the superimposed audio signals A to D generated by the video distribution device 3 are transmitted to each of the HMD for user A_4A to HMD for user C_4C and the notebook PC for user D_4D via the intern& 6 and 5G networks, and each of the 5G base station A_5A to 5G base station D_5D and each of the smartphone for user A_41A to smartphone for user D_41D.

### Embodiment 17

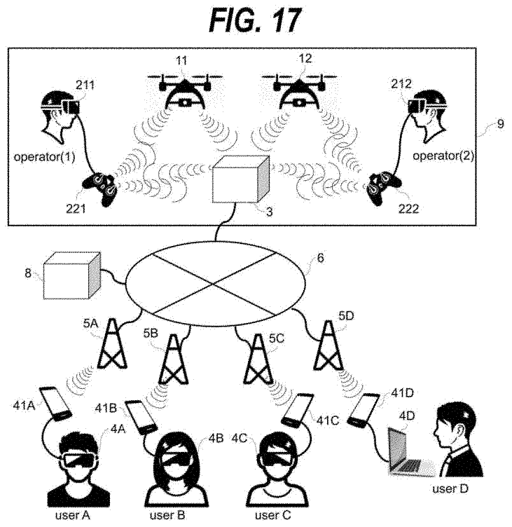

FIG. 17 is a schematic view illustrating the configuration and function of a live video distribution system and an on-the-spot system that realize a live video distribution method according to Embodiment 17 of the present invention, and the function of a video distribution device and a video archive device used in the live video distribution method.

The functions of the components of the live video distribution system of this embodiment (aerial shoot drone(1)_11, aerial shoot drone(2)_12, HMD for operator(1)_211, HMD for operator(2)_212, drone controller(1)_221 , drone controller(2)_222, video distribution device 3, HMD for user A_4A to HMD for user C_4C, notebook PC for user D_4D, smartphone for user A_41A to smartphone for user D_41D, video archive device 8, on-the-spot system 9) are the same as those of the Embodiment 14 except for the points described up to paragraph [0180].

In this embodiment, the device for user A to device for user C is composed of the smartphone for user A_41A to smartphone for user C_41C in addition to the HMD for user A_4A to HMD for user C_4C, and the device for user D is composed of the smartphone for user D_41D in addition to the notebook PC for user D_4D. The HMD for user A_4A to HMD for user C_4C and the notebook PC for user D_4D are connected to the smartphone for user A_41A to smartphone for user D_41D by wire with a communication cable, respectively.

The smartphone for user A_41A to smartphone for user D_41D have a 5G communication function. Each of the HMD for user A_4A to HMD for user C_4C and notebook PC for user D_4D does not transmit and receive signals to and from each of the ISP server A_7A to ISP server C_7 C and ISP server D_7D, respectively, but transmits and receives signals to and from each of the 5G base station A_5A to 5G base station C_5C and the 5G base station D_5D via the smartphone for user A_41A to smartphone for user D_41D.

### Embodiment 18

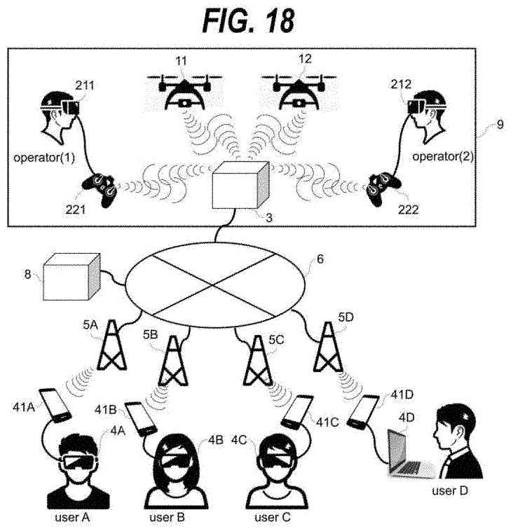

FIG. 18 is a schematic view illustrating the configuration and function of a live video distribution system and an on-the-spot system that realize a live video distribution method according to Embodiment 18 of the present invention, and the function of a video distribution device and a video archive device used in the live video distribution method.

The functions of the components of the live video distribution system of this embodiment (aerial shoot drone(1)_11, aerial shoot drone(2)_12, HMD for operator(1)_211, HMD for operator(2)_212, drone controller(1)_221 , drone controller(2)_222, video distribution device 3, HMD for user A_4A to HMD for user C_4C, notebook PC for user D_4D, smartphone for user A_41A to smartphone for user D_41D, video archive device 8, on-the-spot system 9) are the same as those of the Embodiment 15 except for the points described up to paragraph [0184].

In this embodiment, the device for user A to device for user C is composed of the smartphone for user A_41A to smartphone for user C_41C in addition to the HMD for 2 5 user A_4A to HMD for user C_4C, and the device for user D is composed of the smartphone for user D_41D in addition to the notebook PC for user D_4D. The HMD for user A_4A to HMD for user C_4C and the notebook PC for user D_4D are connected to the smartphone for user A_41A to smartphone for user D_41D by wire with a communication cable, respectively.

The smartphone for user A_41A to smartphone for user D_41D have a 5G communication function. Each of the HMD for user A_4A to HMD for user C_4C and notebook PC for user D_4D does not transmit and receive signals to and from each of the ISP server A_7A to ISP server C_7 C and ISP server D_7D, respectively, but transmits and receives signals to and from each of the 5G base station A_5A to 5G base station C_5C and 5G base station D_5D via the smartphone for user A_41A to smartphone for user D_41D.

### Embodiment 19

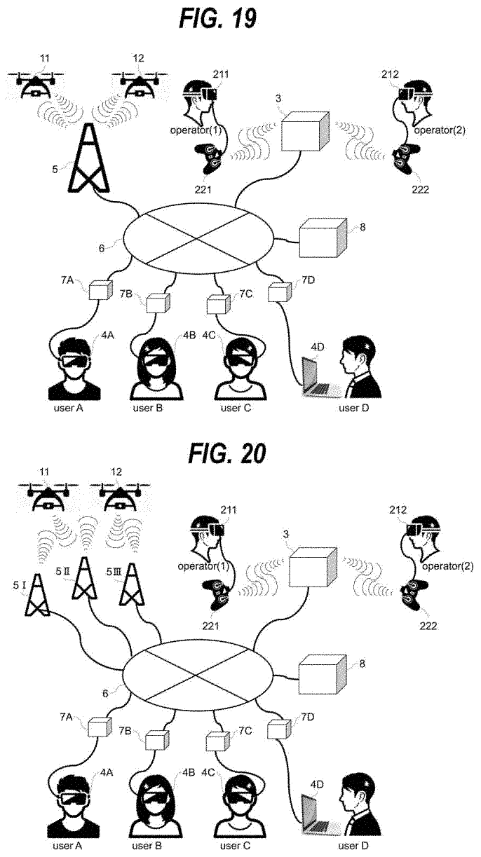

FIG. 19 is a schematic view illustrating the configuration and function of a live video distribution system that realizes a live video distribution method according to Embodiment 19 of the present invention, and the function of a video distribution device and a video archive device used in the live video distribution method.

The functions of the components of the live video distribution system of this embodiment (aerial shoot drone(1)_11, aerial shoot drone(2)_12, HMD for operator(1)_211, HMD for operator(2)_212, drone controller(1)_221 , drone controller(2)_222, video distribution device 3, HMD for user A_4A to HMD for user C_4C, notebook PC for user D_4D, video archive device 8) are the same as those of the Embodiment 15 except for the points described up to paragraph [0189].

In this embodiment, the transmission and reception of signals from the aerial shoot drone(1)_11 and the aerial shoot drone(2)_12 to the video distribution device 3 is not performed by direct wireless communication, but via a public network.

That is, the aerial shoot drone(1)_11 and the aerial shoot drone(2)_12 transmit the spherical 3D live video signal generated based on the results taken by two spherical cameras to the 5G base station 5, which is the base station of the 5G network, and the spherical 3D live video signal is transmitted to the video distribution device 3 via a 5G network (not shown in FIG. 19) and the interne 6.

In addition, the video distribution device 3 transmits the f light control signal received from drone controller(1)_221 from the 5G base station 5 to the aerial shoot drone(1)_11 via the intemet 6 and the 5G network after performing the necessary processing. The rotation speed of the rotor blade of the aerial shoot drone(1)_11 is controlled based on the received flight control signal, and the aerial shoot drone 1 flies as intended by the operator. In addition, the video distribution device 3 transmits the f light control signal received from drone controller(2)_222 from the 5G base station 5 to the aerial shoot drone(2)_12 via the intern& 6 and the 5G network after performing the necessary processing. The rotation speed of the rotor blades of the aerial shoot drone(2)_12 is controlled based on the received flight control signal, and the aerial shoot drone(2)_12 flies as intended by the operator.

### Embodiment 20

FIG. 20 is a schematic view illustrating the configuration and function of a live video distribution system that realizes a live video distribution method according to Embodiment 20 of the present invention, and the function of a video distribution device and a video archive device used in the live video distribution method.

The functions of the components of the live video distribution system of this embodiment (aerial shoot drone(1)_11, aerial shoot drone(2)_12, HMD for operator(1)_211, HMD for operator(2)_212, drone controller(1)_221 , drone controller(2)_222, video distribution device 3, HMD for user A_4A to HMD for user C_4C, notebook PC for user D_4D) are the same as those of the Embodiment 19 except for the points described in the next paragraph.

In this embodiment, the aerial shoot drone(1)_11 and the aerial shoot drone(2)_12 do not transmit and receive signals to and from only one 5G base station 5 (5G base station 5), but transmit and receive signals to and from the 5G base station I_5I to 5G base station III 5111 in a cellular manner. In this embodiment, there are three 5G base stations, the 5G base station I 51 to 5G base station III 5111, but the number of 5G base stations can be increased in principle.

### Embodiment 21

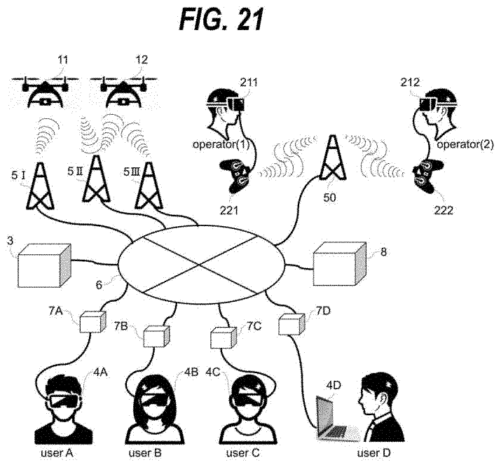

FIG. 21 is a schematic view illustrating the configuration and function of a live video distribution system that realizes a live video distribution method according to Embodiment 21 of the present invention, and the function of a video distribution device and a video archive device used in the live video distribution method.

The functions of the components of the live video distribution system of this embodiment (aerial shoot drone(1)_11, aerial shoot drone(2)_12, HMD for operator(1)_211, HMD for operator(2)_212, drone controller(1)_221 , drone controller(2)_222, video distribution device 3, HMD for user A_4A to HMD for user C_4C, notebook PC for user D_4D, video archive device 8) are the same as those of the Embodiment 20 except for the points described up to paragraph [0199].

In this embodiment, the transmission/reception of signals between the device 21 for operator (1) and the device 22 for operator (2) and the video distribution device 3 is not performed by direct wireless communication, but via a public network.

That is, the HMD for operator(1)_211 transmits a display range setting signal generated based on the detection result of the sensor that detects the movement of the head and eyeball of the operator (1) to the 5G base station 50, and the display range setting signal is transmitted to the video distribution device 3 via the 5G network and the internet 6. On the other hand, the HMD for operator(2)_212 transmits a display range setting signal generated based on the detection result of the sensor that detects the movement of the head and eyeball of the operator (2) to the 5G base station 50, and the display range setting signal is transmitted to the video distribution device 3 via the 5G network and the internet 6.

The video distribution device 3 generates a 3D live video signal to be transmitted to the HMD for operator(1)_211 from the display range setting signal received from the HMD for operator(1)_211 and the spherical 3D live video signal received from the aerial shoot drone(1)_11, and the 3D live video signal is finally transmitted from the 5G base station 50 to the HMD for operator(1)_211 via the internet 6 and the 5G network. On the other hand, the video distribution device 3 generates a 3D live video signal to be transmitted to the HMD for operator(2)_212. from the display range setting signal received from the HMD for operator(2)_212 and the spherical 3D live video signal received from the aerial shoot drone(2)_12, and the 3D live video signal is finally transmitted from the 5G base station 50 to the HMD for operator(2)_212 via the internet 6 and the 5G network.

In addition, the HMD for operator(1)_211 and the HMD for operator(2)_212 transmit an audio signal generated based on the result of sound collection by the integrally configured microphone to the 5G base station 50, and the audio The signal is transmitted to the video distribution device 3 via the 5G network and the internet 6. On the other hand, the superimposed audio signal 0 generated by the video distribution device 3 is finally transmitted from the 5G base station 50 to the HMD for operator(1)_211 and the HMD for operator(2)_212 via the internet 6 and the 5G network.

In addition, the HMD for operator(1)_211 and the HMD for operator(2)_212 transmit an audio signal generated based on the result of sound collection by the integrally configured microphone to 5G base station 50, the audio signal is transmitted to the video distribution device 3 via the 5G network and the internet 6. On the other hand, the superimposed audio signal 0 generated by the video distribution device 3 is transmitted finally from the 5G base station 50 to the HMD for operator(1)_211 and the HMD for operator(2)_212 via the internet 6 and the 5G network.

### Embodiment 22

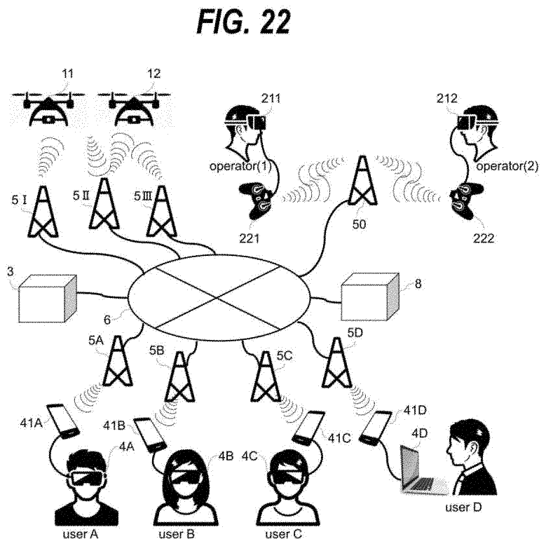

FIG. 22 is a schematic view illustrating the configuration and function of a live video distribution system that realizes a live video distribution method according to Embodiment 22 of the present invention, and the function of a video distribution device and a video archive device used in the live video distribution method.

The functions of the components of the live video distribution system of this embodiment (aerial shoot drone(1)_11, aerial shoot drone(2)_12, HMD for operator(1)_211, HMD for operator(2)_212, drone controller(1)_221 , drone controller(2)_222, video distribution device 3, HMD for user A_4A to HMD for user C_4C, notebook PC for user D_4D, video archive device 8) are the same as those of the Embodiment 21 except for the points described up to paragraph [0203].

In this embodiment, the device for user A to device for user C is composed of the smartphone for user A_41A to smartphone for user C_41C in addition to the HMD for user A_4A to HMD for user C_4C, and the device for user D is composed of the smartphone for user D_41D in addition to the notebook PC for user D_4D. The HMD for user A_4A to HMD for user C_4C and the notebook PC for user D_4D are connected to the smartphone for user A_41A to smartphone for user D_41D by wire with a communication cable, respectively.

The smartphone for user A_41A to smartphone for user D_41D have a 5G communication function. Each of the HMD for user A_4A to HMD for user C_4C and the notebook PC for user D_4D does not transmit and receive signals to and from each of the ISP server A_7A to ISP server C_7 C and ISP server D_7D, respectively, but transmits and receives signals to and from each of the 5G base station A_5A to 5G base station C_5C and 5G base station D_5D via the smartphone for user A_41A to smartphone for user D_41D.

### Embodiment 23

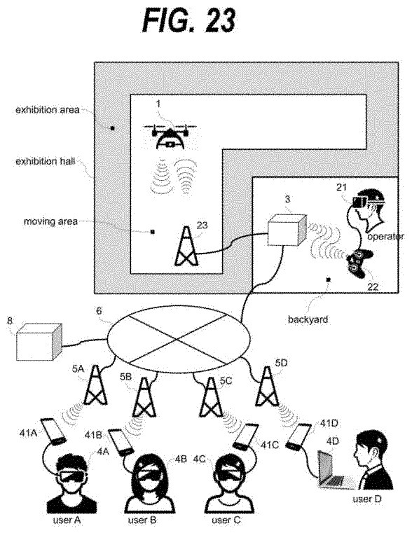

FIG. 23 is a schematic view illustrating the configuration and function of a live video distribution system that realizes a live video distribution method according to Embodiment 23 of the present invention, and the function of a video distribution device and a video archive device used in the live video distribution method.

In this embodiment, the live video distribution method of the present invention is applied to the distribution of the video of the live video signal of the exhibit exhibited in the exhibition hall (including a museum).

In this embodiment, there is only one operator, therefore, the aerial shoot drone is only the aerial shoot drone 1, and the operator device is also only one set of the HMD for operator 21 and the drone controller 22. The functions of the HMD for user A_4A to HMD for user C_4C and the notebook PC for user D_4D are the same as those in Embodiment 18 except that each of users A to C and user D cannot select from a plurality of aerial shoot drones and can enjoy only the video of the live video signal of the target shooted by the spherical camera of the aerial shoot drone 1.

In this embodiment, the exhibition hall is divided into the following three areas.
Exhibition area . . . An area where exhibits are exhibited and people who are looking at the exhibits are prohibited from entering.
Moving area . . . An area where people who see the exhibits can move
Backyard . . . Areas other than the exhibition area and moving area

The operator is located in the backyard, and the operator operates the drone controller 22 while watching the video of the live video signal projected from the left and right projection units of the HMD for operator 21. The operator device (the HMD for operator 21 and the drone controller 22) and the video distribution device 3 transmit and receive signals in the same manner as in Embodiment 2.

On the other hand, a drone control antenna 23 is installed in the moving area. The drone control antenna 23 is wired to the video distribution device 3. The drone control antenna 23 mediates the transmission and reception of signals between the aerial shoot drone 1 and the video distribution device 3. As a result, the aerial shoot drone 1 and the video distribution device 3 can transmit and receive signals via the drone control antenna 23 in the same manner as in the second embodiment.

In addition, the aerial shoot drone 1 is provided with an approach determination means for determining approach to the exhibition area based on the results taken by two spherical cameras. This makes it possible to avoid contact with the exhibits.

### Embodiment 24

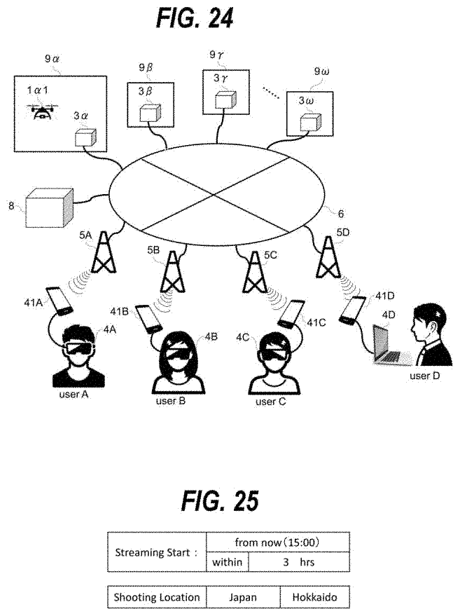

FIG. 24 is a schematic view illustrating the configuration and function of a live video distribution system and an on-the-spot system that realize a live video distribution method according to Embodiment 24 of the present invention, and the functions of a video distribution device and a video archive device used in the live video distribution method.

The functions of the components of the live video distribution system of this embodiment (aerial shoot drone α1_1α1, on-the-spot system α_9α to on-the-spot systemω_9ω, video distribution device α_3α to video distribution deviceω_3ω, HMD for user A_4A to HMD for user C_4C, notebook PC for user D_4D, smartphone for user A_41A to smartphone for user D_41D, video archive device 8, on-the-spot system 9) are the same as those of the Embodiment 16 except for the points described up to paragraph.

The live video distribution system of this embodiment includes an on-the-spot system α_9α to an on-the-spot system ω_9ω as components, and these on-the-spot systems are deployed in areas remote from each other. In addition, each of the on-the-spot system α_9α to on-the-spot system ω_9ω is equipped with a video distribution device a 3a to a video distribution device ω_3ω, and a plurality of operators for controlling the aerial shoot drone using the operator device are deployed.

In addition, signals are exchanged between the video distribution device a 3a to video distribution device ω_3ω and the HMD for user A_4A to HMD for user C_4C and the notebook PC for user D_4D via the intemet 6 and the video archive device 8.

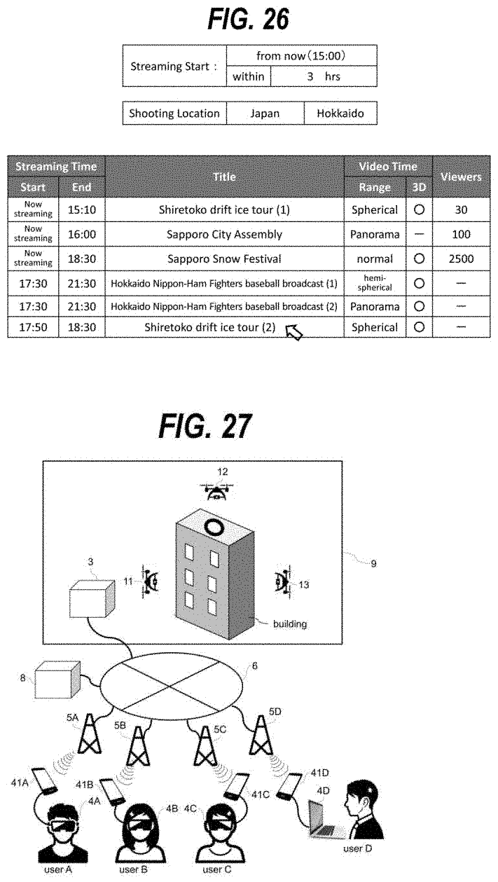

Hereinafter, the live video distribution method in this embodiment will be described with reference to FIG. 25 and FIG. 26, taking the user D using the notebook PC for user D_4D and the smartphone for user D_41D as an example.

The user D operates the input means of the notebook PC for user D_4D and inputs the ID and password. The entered information is transmitted to the video archive device 8 via the smartphone for user D_41D, the 5G base station D_5D, 5G network and the intern& 6, and as a result of authentication, the notebook PC for user D_4D can access the video archive device 8.

The live video selection screen shown in FIG. 21 is displayed on the display of the notebook PC for user D_4D that has accessed the video archive device 8. When the user D operates the input means of the notebook PC for user D_4D to input the “Streaming Start” and the “Shooting Location”, the input information is transmitted to the video archive device 8 via the smartphone for user D_41D, the 5G base station D_5D, 5G network and the intemet 6. The video archive device 8 creates a list of applicable live videos based on the flight plans of all aerial shoot drones belonging to the on-the-spot system α_9α to on-the-spot system ω_9ω, and transmits the list to the notebook PC for user D_4D via the intemet 6, 5G networks, the 5G base station D_5D and the smartphone for user D_41D. The display of the notebook PC for user D_4D that has received the list displays a list of the corresponding live videos as shown in FIG. 26.

When the user D operates the input means of the notebook PC for user D_4D and selects the live video already being distributed from the list, the screen transitions to the video display screen. On the other hand, if a live video whose distribution is started after that point is selected, the screen transitions to the standby screen, and when the streaming distribution of the selected live video is started, the screen transitions to the video display screen.

Hereinafter, the paragraphs up to [0225] are described on the premise that the user D selects “Shiretoko drift ice tour (2)” and the aerial shoot drone α1_1α1 operated by operator al deployed in the on-the-spot system α_9α shoots the live video.

At the scheduled streaming start time (17:50), the aerial shoot drone α1_1α1 rotates each rotor blade to ascend and quickly move over Shiretoko based on the flight control signal transmitted from the drone controller operated by operator al. At the same time, transmission of the “spherical 3D live video signal of the drift ice to be shooted” and the “live audio signal of the surrounding sound” to the video distribution device α_3α is started.

In addition, the aerial shoot drone α1_1α1 continuously generates a shooting position signal based on the measurement result of its own GPS sensor while transmitting the spherical 3D live video signal, and wirelessly transmits the shooting position signal to the video distribution device α_3α together with the spherical 3D live video signal.

The video distribution device α_3α converts the received spherical 3D live video signal into a two-dimensional live video signal, and then transmits it to the video archive device 8 via the internet 6 together with the received live audio signal. At the same time, the video distribution device α_3α writes the received spherical 3D live video signal and live audio signal to its own storage means as temporary data. At that time, the reception time of the spherical 3D live video signal and the live audio signal is set as the shooting time, and the shooting position is specified based on the shooting position signal transmitted from the aerial shoot drone α1_1α1, and then temporary data is written as video/audio data with shooting time/shooting position.

Further, the video distribution device α_3α creates a video/audio data file from the temporary data when the shooting of the aerial shoot drone α1_1α1 is completed and the signal transmission is completed, and transmits the video/audio data file to the video archive device 8. On the other hand, the video archive device 8 holds a list of video/audio data files stored by itself, and updates the list of video/audio data files each time it receives a data file.

On the other hand, the notebook PC for user D_4D starts receiving two-dimensional live video signal and live audio signal from the video archive device 8 via the internet 6, 5G network, the 5G base station D_5D and the smartphone for user D_41D. At the same time, the display screen is switched to the video display screen. In the video display screen, the user D can display the live video in the display range he/she wants to see by operating the input means of the notebook PC for user D_4D. In addition, the sound based on the received live audio signal is emitted from the micro speaker of the notebook PC for user D_4D.

The video taken by the aerial shoot drone α1_1α1 (“Shiretoko drift ice tour (2)”) can be live-streamed to user devices used by users other than user D. The video archive device 8 counts the number of user devices currently livestreaming the video and the total number of user devices to which live video was distributed during the livestreaming time. Of these, the number of user devices currently being livestreamed is displayed in the “viewers” in FIG. 26, and the total number of user devices distributed during the live streaming distribution time is added as data to the video/audio data file stored in the video archive device 8.

In this embodiment, the functions of aerial shoot drones, HMD's for operators, drone controllers and the video distribution device α_3α to video distribution device ω_3ω constituting the on-the-spot system α_9α to on-the-spot system ω_9ω are the same as the functions of the aerial shoot drone(1)_11, the aerial shoot drone(2)_12, the HMD for operator(1)_211, the HMD for operator(2)_212, the drone controller(1)_221, the drone controller(2)_222 and the video distribution device 3 constituting Example 16, but they can also be the same as that of Example 17 and Example 18.

Further, in this embodiment, the video archive device 8 has a function of transmitting a live video signal and a live audio signal to the user device, it is also possible for the video distribution device provided separately from the video archive device 8 to have the function to transmit live video signals and live audio signals to the user device.

### Embodiment 25

FIG. 27 is a schematic view illustrating The configuration and function of a live video distribution system and an on-the-spot system that realize a live video distribution method according to Embodiment 25 of the present invention, and the functions of a video distribution device and a video archive device used in the live video distribution method.

The functions of the components of the live video distribution system of this embodiment (aerial shoot drone(1)_11, aerial shoot drone(2)_12, aerial shoot drone(3)_13, video distribution device 3, HMD for user A_4A to HMD for user C_4C , notebook PC for user D_4D, smartphone for user A_41A to smartphone for user D_41D, video archive device 8, on-the-spot system 9) are the same as those of the Embodiment 16 except for the points described up to paragraph [0237].

In this embodiment, 3 aerial shoot drone (the aerial shoot drone(1)_11 to aerial shoot drone(3)_13) are deployed in the on-the-spot system 9. Each of the aerial shoot drone(1)_11 to aerial shoot drone(3)_13 has one CCD camera module, and the CCD camera module is installed on a 3-way head. The operators (1) to (3) that control each of the aerial shoot drone(1)_11 to aerial shoot drone(3)_13 can rotate the 3-way head around three axes of rotation by operating the drone controller(1)_221 to drone controller (3)_223 (not shown in FIG. 27). Accordingly, front/rear/left/right tilt and pan of the CCD camera module can be realized, and an image of a desired image capturing range can be captured.

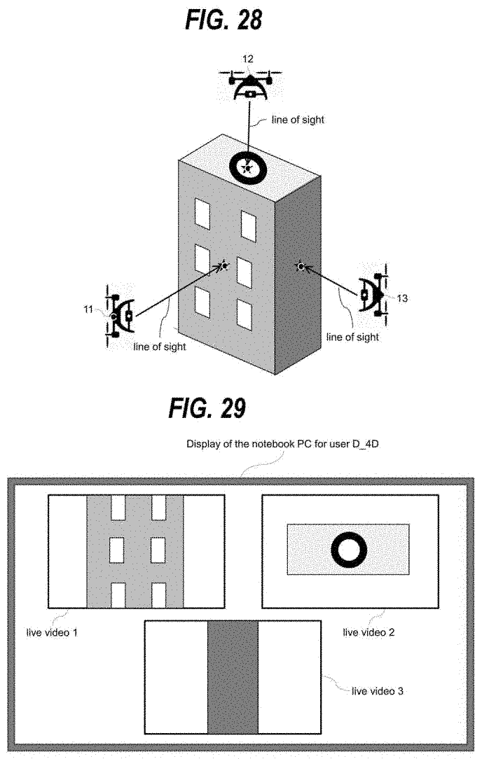

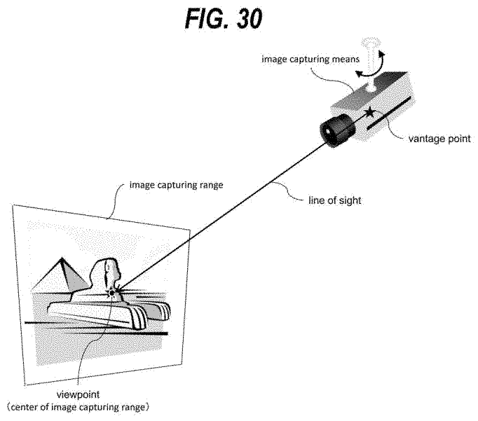

In this way, the image capturing means mounted on each aerial shoot drone shoots the same building from different vantage points. The viewpoint (indicated by* in the figure) and line of sight of each image capturing means of the aerial shoot drone(1)_11 to aerial shoot drone(3)_13 are shown in FIG. 28.

Each of the aerial shoot drone(1)_11 to aerial shoot drone(3)_13 generates a two-dimensional video signal based on the result captured by the CCD camera module, and wirelessly transmits the two-dimensional video signal to the video distribution device 3 via the drone controller(1)_221 to drone controller (3)_223.

Further, the video distribution device 3 simultaneously transmits the two-dimensional video signals received from each of the aerial shoot drone(1)_11 to aerial shoot drone(3)_13 to each of the smartphone for user A_41A to smartphone for user D_41 via the intemet 6 and 5G networks.

Hereinafter, the live video distribution method in this embodiment will be described with reference to FIG. 29, taking the user D using the notebook PC for user

D_4D and the smartphone for user D_41D as an example.

The following three types of live video received via the smartphone for user D_41D can be displayed in parallel on the display of the notebook PC for user D_4D.
Live video 1 Live video based on the results taken by the aerial shoot drone(1)_11
Live video 2 Live video based on the results taken by the aerial shoot drone(2)_12
Live video 3 Live video based on the results taken by the aerial shoot drone(3)_13

Further, the user D can display only one live video of the live video 1 to live video 3 in full screen on the display of the notebook PC for user D_4D.

Then, the switching between the parallel display and the full screen display can be realized by the user D operating the input means of the notebook PC for user D_4D.

In this embodiment, the building is photographed from different vantage points using a plurality of aerial shoot drones, but, for example, it is possible to use a plurality of aerial shoot drones to shoot concerts and sporting events at one venue from different vantage points.

Further, as in Embodiment 24, it is possible to simultaneously receive different live video signals from a plurality of on-the-spot systems deployed in remote areas and display the corresponding live video in parallel or select one live video from them and display it in full screen.

### INDUSTRIAL APPLICABILITY

The present invention can be used in an industry which manufactures unmanned aerial vehicles (aerial shoot drone, etc.), unmanned vehicles, walking robots, and other unmanned moving devices and their peripheral devices and ancillary devices, an industry which manufactures video distribution devices, and a user device (particularly video display means such as HMD) and an industry which manufactures video archive devices. It can also be used in an industry which provides services related to observation using the live video distribution method (particularly tourism services). Reference Signs List

1 . . . aerial shoot drone

11 . . . aerial shoot drone(1)

12 . . . aerial shoot drone(2)

13 . . . aerial shoot drone(3)
1 α1 . . . aerial shoot drone α1

21 . . . HMD for operator

211 . . . HMD for operator(1)

212 . . . HMD for operator(2)

22 . . . drone controller

221 . . . drone controller(1)

222 . . . drone controller(2)

23 . . . drone control antenna

3 . . . video distribution device

3α . . . video distribution device α

3β . . . video distribution device β

3γ . . . video distribution device γ

3ω video distribution device ω

4A . . . HMD for user A

4B . . . HMD for user B

4C . . . HMD for user C

4D . . . notebook PC for user D

41A . . . smartphone for user A

41B . . . smartphone for user B

41C . . . smartphone for user C

41D . . . smartphone for user D

5 . . . 5G base station

5I . . . 5G base station I

SIII . . . 5G base station II

5III . . . 5G base station III

50 . . . 5G base station

5A . . . 5G base station A

5B . . . 5G base station B

5C . . . 5G base station C

5D . . . 5G base station D

6 . . . the interne

7A . . . ISP server A

7B . . . ISP server B

7C . . . ISP server C

7D . . . ISP server D

8 . . . video archive device

9 . . . on-the-spot system

9α . . . on-the-spot system α

9β . . . on-the-spot system β

9γ . . . on-the-spot system γ

9ω . . . on-the-spot system ω

1. A live video distribution method comprising:
transmitting a live video signal of a shooting target is simultaneously from a video distribution device to a user device used by each of a plurality of user;
displaying the video of the live video signal on a display means provided in the user device;
wherein the live video signal is generated based on the result of shooting the shooting target by the image capturing means provided by the unmanned moving device that moves in the space near the shooting target; and
wherein the unmanned moving device moves based on a movement control signal generated based on the result of an operator other than the plurality of users operating the operator device.

2. The live video distribution method according to claim 1:
wherein all or part of the plurality of users are located remote from the unmanned moving device; and
wherein the video distribution device receives a live video signal from the unmanned moving device, performs necessary processing on the live video signal and then transmits it to the user device used by the user located at the remote location via the public network.

3. The live video distribution method according to claim 1:
wherein there are a plurality of unmanned moving devices;
wherein the plurality of unmanned moving devices simultaneously shoot substantially the same shooting target from different vantage points depending on the shooting means provided for each; and
wherein a plurality of live video signals with different display ranges generated based on the result are simultaneously transmitted from the video distribution device to the user device.

4. The live video distribution method according to claim 3:
wherein each of the plurality of users selects which live video signal is received by their own user device among live video signals generated based on the result of shooting by the image capturing means of said plurality of unmanned moving devices and the video of the selected live video signal is displayed on the display means provided in the user device.

5. The live video distribution method according to claim 1:
wherein there are a plurality of unmanned moving devices;
wherein the plurality of unmanned moving devices are deployed in a plurality of areas remote from each other; and
wherein each of the plurality of users selects which live video signal is received by their own user device among live video signals generated based on the result of shooting by the image capturing means of unmanned moving devices deployed in said plurality of areas and the video of the selected live video signal is displayed on the display means provided in the user device.

6. The live video distribution method according to claim 1:
wherein the image capturing means provided by the unmanned moving device captures a wide-angle image including a panoramic image, an hemispherical image, and a spherical image; and
wherein a display means of the user device cuts out and displays an image in a predetermined display range (hereinafter abbreviated as “predetermined display range image”) from the wide-angle video.

7. The live video distribution method according to claim 1:
wherein a live operator audio signal, which is a collection of sounds emitted by an operator using the operator device or a person in the vicinity of the operator, is simultaneously transmitted from the video distribution device to the plurality of user devices directly or via a public network and live audio is simultaneously emitted by the sound emitting means of the plurality of user devices.

8. The live video distribution method according to claim 7:
wherein all or part of the plurality of user devices has a sound collecting means for collecting the sound emitted by the user who uses the user device;
wherein all or part of the live user audio signal based on the result of sound collection by the user device sound collecting means and the superimposed audio signal superimposed with the live operator audio signal are directly or via a public network from the video distribution device; and
wherein a live sound is simultaneously emitted by the sound emitting means of the plurality of user devices.

9. A video distribution device, to be used in the live video distribution method according to claim 1:
wherein a live video signal is received from the unmanned moving device, necessary processing is performed on the live video signal, and then the live video signal is simultaneously transmitted to the plurality of user devices directly or via a public network.

10. A video distribution device to be used in the live video distribution method according to claim 3:
wherein live video signals with different image capturing ranges are received from each of the plurality of unmanned moving devices, necessary processing is performed for each of the live video signals with different image capturing ranges, and then they are simultaneously transmitted to the plurality of user devices directly or via a public network.

11. The video distribution device according to claim 9 to be used in a live video distribution method,
wherein an unmanned moving device selection signal based on the selection result of a user who uses the user device is received from the user device; and
wherein it is determined to which user device the live video signal received from a plurality of unmanned moving devices is transmitted based on the unmanned moving device selection signal.

12. The video distribution device according to claim 9,
wherein a region selection signal based on the selection result of the user who uses the user device is received from the user device; and
wherein it is determined to which user device the live video signal received from a plurality of unmanned moving devices is transmitted based on the region selection signal.

13. The video distribution device according to claim 9,
wherein a wide-angle video signal is received from the unmanned moving device, necessary processing is performed on the wide-angle video signal, and then the wide-angle video signal is simultaneously transmitted to the plurality of user devices directly or via a public network.

14. The video distribution device according to claim 13:
wherein a predicted display range video signal for transmitting the predicted display range video cut out from the wide-angle image is generated, and the predicted display range video signal is transmitted to the user device.

15. The video distribution device according to claim 10,
wherein the live operator audio signal is simultaneously transmitted to the plurality of user devices, either directly or via a public network.

16. The video distribution device according to claim 15,
wherein a live user audio signal is received from all or a part of the plurality of user devices, and a superimposed audio signal is generated by superimposing the live operator audio signal on all or a part of the live user audio signal; and
wherein the superimposed audio signal is simultaneously transmitted to the plurality of user devices, either directly or via a public network.

17. The video distribution device according to claim 10:
wherein recording of the video data transmitted by the live video signal is started substantially at the same time as the transmission of the live video signal is started, and the video data is saved as a video data file substantially at the same time as the transmission of the live video signal is completed.

18. A video archive device for storing a video data file generated by the video distribution device according to claim 17.
